(19) United States
(12) Patent Application Publication
(10) Pub. No.: US 2026/0367384 A1
(43) Pub. Date: Nov. 19, 2026

(54) LENS MECHANISM AND SIGHT

(71) Applicant: ZHUHAI MEFO OPTICAL INSTRUMENTS CO., LTD., Zhuhai (CN)

(72) Inventors: Yinquan HE, Zhuhai (CN); Xiping YU, Zhuhai (CN); Jiyuan TIAN, Zhuhai (CN); Dayun LIN, Zhuhai (CN); Hui YANG, Zhuhai (CN)

(73) Assignee: ZHUHAI MEFO OPTICAL INSTRUMENTS CO., LTD., Zhuhai (CN)

(21) Appl. No.: 19/521,946

(22) PCT Filed: Oct. 14, 2024
(86) PCT No.: PCT/CN2024/124607

§ 371 Date: Mar. 23, 2026

(30) Foreign Application Priority Data
Jul. 4, 2024 (CN) 202410896078.X

(51) Int. Cl. G02B 23/16; G02B 23/12; G02B 27/01

(52) U.S. Cl. CPC G02B 23/16; G02B 23/12; G02B 27/0189

(57) ABSTRACT

Provided are a lens mechanism and sight. The lens mechanism includes a main objective lens set, an eyepiece set, and a switching assembly, where the switching assembly is movably disposed between the main objective lens set and the eyepiece set; and the switching assembly is provided with a reticle and a night vision assembly. The sight includes a lens barrel, where the sight further includes the above lens mechanism; and at least part of the switching assembly is movably disposed inside the lens barrel. Compared with the sight in the prior art, the reticle and the night vision assembly can be driven to move simply by toggling the switching assembly between a first state and a second state, so as to realize rapid switching of the lens mechanism between a white light state and a night vision state.

### CROSS-REFERENCE TO THE RELATED APPLICATIONS

This application is the national phase entry of International Application No. PCT/CN2024/124607, filed on Oct. 14, 2024, which is based upon and claims priority to Chinese Patent Application No. 202410896078.X, filed on Jul. 4, 2024, the entire contents of which are incorporated herein by reference.

### TECHNICAL FIELD

The present disclosure belongs to the technical field of optical instruments, and in particular relates to a lens mechanism and sight.

### BACKGROUND

A sight, also referred to as an optical aiming device, is an optical device designed to assist a shooter in accurately targeting an object. It operates on the principles of optical imaging and reflection to achieve precise aiming. Typically, a white light sight is used during daytime, while a night vision sight is used at night, necessitating that the shooter switches different types of sights according to different environments. This replacement requires re-zeroing the sight to align the reticle with the bullet impact point, which involves complicated and tedious operations. Currently, some sights on the market incorporate two operating modes of white light aiming and night vision aiming to accommodate daytime and nighttime uses, respectively. However, these sights fail to achieve rapid switching between white light aiming and night vision aiming.

### SUMMARY

An objective of the present disclosure is to provide a lens mechanism and a sight, which intends to solve the technical problem in the prior art that a sight cannot achieve rapid switching between white light aiming and night vision aiming.

The present disclosure is implemented as follows. In a first aspect, a lens mechanism is provided, including: a main objective lens set, an eyepiece set, and a switching assembly, where the main objective lens set and the eyepiece set are disposed at an interval along a main optical axis; the switching assembly is movably disposed between the main objective lens set and the eyepiece set; the switching assembly is provided with a reticle and a night vision assembly; the switching assembly has a first state and a second state; when the switching assembly is in the first state, the reticle is located on the main optical axis and the night vision assembly deviates from the main optical axis; and when the switching assembly is in the second state, the night vision assembly is located on the main optical axis and the reticle deviates from the main optical axis.

In an optional embodiment, when the switching assembly is in the first state, a pattern surface of the reticle coincides with an image-side focal plane of the main objective lens set; when the switching assembly is in the second state, a light-receiving surface of the night vision assembly coincides with the image-side focal plane of the main objective lens set, and a display surface of the night vision assembly coincides with an object-side focal plane of the eyepiece set; the lens mechanism further includes a first compensation lens; the first compensation lens is movable between a first position corresponding to the first state and a second position corresponding to the second state; at the first position, the first compensation lens is located on the main optical axis and between the reticle and the eyepiece set, and the first compensation lens is configured to make the object-side focal plane of the eyepiece set coincide with the image-side focal plane of the main objective lens set; and at the second position, the first compensation lens deviates from the main optical axis.

In an optional embodiment, the first compensation lens is disposed on the switching assembly and is movable with the switching assembly; the first compensation lens is disposed opposite to the reticle; and an optical axis of the first compensation lens coincides with an optical axis of the reticle.

In an optional embodiment, when the switching assembly is in the first state, an image-side focal plane of the main objective lens set coincides with a pattern surface of the reticle, and an object-side focal plane of the eyepiece set also coincides with the pattern surface of the reticle; when the switching assembly is in the second state, a light-receiving surface of the night vision assembly coincides with the image-side focal plane of the main objective lens set; the lens mechanism includes a second compensation lens; the second compensation lens is movable between a third position corresponding to the first state and a fourth position corresponding to the second state; at the fourth position, the second compensation lens is located on the main optical axis and between the night vision assembly and the eyepiece set, such that when the switching assembly is in the second state, a display surface of the night vision assembly coincides with the object-side focal plane of the eyepiece set; and at the third position, the second compensation lens deviates from the main optical axis.

In an optional embodiment, the second compensation lens is disposed on the switching assembly and is movable with the switching assembly; the second compensation lens is disposed opposite to the night vision assembly; and an optical axis of the second compensation lens coincides with an optical axis of the night vision assembly.

In an optional embodiment, when the switching assembly is in the first state, a pattern surface of the reticle coincides with an object-side focal plane of the eyepiece set; when the switching assembly is in the second state, a light-receiving surface of the night vision assembly coincides with an image-side focal plane of the main objective lens set, and a display surface of the night vision assembly coincides with the object-side focal plane of the eyepiece set; the lens mechanism further includes a third compensation lens; the third compensation lens is movable between a fifth position corresponding to the first state and a sixth position corresponding to the second state; at the fifth position, the third compensation lens is located on the main optical axis and between the reticle and the main objective lens set, and the third compensation lens is configured to make the object-side focal plane of the eyepiece set coincide with the image-side focal plane of the main objective lens set; and at the sixth position, the third compensation lens deviates from the main optical axis.

In an optional embodiment, the third compensation lens is disposed on the switching assembly and is movable with the switching assembly; the third compensation lens is disposed opposite to the reticle; and an optical axis of the third compensation lens coincides with an optical axis of the reticle.

In an optional embodiment, when the switching assembly is in the first state, an image-side focal plane of the main objective lens set coincides with a pattern surface of the reticle, and an object-side focal plane of the eyepiece set also coincides with the pattern surface of the reticle; when the switching assembly is in the second state, a display surface of the night vision assembly coincides with the object-side focal plane of the eyepiece set; the lens mechanism includes a fourth compensation lens; an optical axis of the fourth compensation lens coincides with an optical axis of the night vision assembly; the fourth compensation lens is movable between a seventh position corresponding to the first state and an eighth position corresponding to the second state; at the eighth position, the fourth compensation lens is located on the main optical axis and between the night vision assembly and the main objective lens set, such that when the switching assembly is in the second state, the display surface of the night vision assembly coincides with the image-side focal plane of the main objective lens set; and at the seventh position, the fourth compensation lens deviates from the main optical axis.

In an optional embodiment, the fourth compensation lens is disposed on the switching assembly and is movable with the switching assembly; the fourth compensation lens is disposed opposite to the night vision assembly; and the optical axis of the fourth compensation lens coincides with an optical axis of the switching assembly.

In an optional embodiment, the night vision assembly includes an image sensor and a display; the lens mechanism further includes a thermal imaging objective lens set and a thermal imaging core; the thermal imaging core includes a detector and a signal processing unit; the detector is electrically connected to the signal processing unit; and the signal processing unit is electrically connected to the display.

In an optional embodiment, the switching assembly has a degree of freedom to rotate about a rotating shaft; and the rotating shaft is perpendicular to and intersects with the main optical axis.

In an optional embodiment, the lens mechanism satisfies a following relationship:

d₂=d₁/(1−1/n)

where, d₁ denotes a thickness of the reticle, d₂ denotes a thickness of the night vision assembly, and n denotes a refractive index of the reticle.

In a second aspect, a sight is provided, including a lens barrel, where the sight further includes the lens mechanism according to any one of the above embodiments; and at least part of the switching assembly is movably disposed inside the lens barrel.

Compared with the prior art, the first aspect of the present disclosure has the following technical effects. The switching assembly is disposed between the main objective lens set and the eyepiece set, and the reticle and the night vision assembly are disposed on the switching assembly. The switching assembly is movably disposed between the main objective lens set and the eyepiece set, and the switching assembly has a first state and a second state. When the switching assembly is in the first state, the reticle is located on the main optical axis and the night vision assembly deviates from the main optical axis. When the switching assembly is in the second state, the night vision assembly is located on the main optical axis and the reticle deviates from the main optical axis. Compared with the sight in the prior art, the reticle and the night vision assembly can be driven to move simply by toggling the switching assembly between the first state and the second state, so as to realize rapid switching of the lens mechanism between a white light state and a night vision state. It is not necessary to re-zero the sight when replacing the sight, which also reduces the cost of the sight, and enables easy and quick operation, thereby avoiding the loss of combat opportunities due to delay.

It is understood that the beneficial effects of the second aspect can be referred to the relevant description of the first aspect above, and will not be repeated herein.

### BRIEF DESCRIPTION OF THE DRAWINGS

To describe the technical solutions in the embodiments of the present disclosure more clearly, the following briefly introduces the drawings required for describing the embodiments or the prior art. Apparently, the drawings in the following description show merely some embodiments of the present disclosure, and persons of ordinary skill in the art may still derive other drawings from these drawings without creative efforts.

FIG. 1 is a structural schematic view of a lens mechanism according to Embodiment 1 of the present disclosure;

FIG. 2 is a first structural schematic view of a lens mechanism according to Embodiment 2 of the present disclosure;

FIG. 3 is an enlarged view of A shown in FIG. 2;

FIG. 4 is a second structural schematic view of the lens mechanism according to Embodiment 2 of the present disclosure;

FIG. 5 is an enlarged view of B shown in FIG. 4;

FIG. 6 is a first structural schematic view of a lens mechanism according to Embodiment 3 of the present disclosure;

FIG. 7 is a second structural schematic view of the lens mechanism according to Embodiment 3 of the present disclosure;

FIG. 8 is a first structural schematic view of a lens mechanism according to Embodiment 4 of the present disclosure;

FIG. 9 is an enlarged view of C shown in FIG. 8;

FIG. 10 is a second structural schematic view of the lens mechanism according to Embodiment 4 of the present disclosure;

FIG. 11 is an enlarged view of D shown in FIG. 10;

FIG. 12 is a first structural schematic view of a lens mechanism according to Embodiment 5 of the present disclosure;

FIG. 13 is a second structural schematic view of the lens mechanism according to Embodiment 5 of the present disclosure;

FIG. 14 is a first structural schematic view of a lens mechanism according to Embodiment 6 of the present disclosure;

FIG. 15 is an enlarged view of E shown in FIG. 14;

FIG. 16 is a second structural schematic view of the lens mechanism according to Embodiment 6 of the present disclosure;

FIG. 17 is an enlarged view of F shown in FIG. 16;

FIG. 18 is a first structural schematic view of a lens mechanism according to Embodiment 7 of the present disclosure;

FIG. 19 is a second structural schematic view of the lens mechanism according to Embodiment 7 of the present disclosure;

FIG. 20 is a first structural schematic view of a lens mechanism according to Embodiment 8 of the present disclosure;

FIG. 21 is an enlarged view of G shown in FIG. 20;

FIG. 22 is a second structural schematic view of the lens mechanism according to Embodiment 8 of the present disclosure;

FIG. 23 is an enlarged view of H shown in FIG. 22;

FIG. 24 is a first structural schematic view of a lens mechanism according to Embodiment 9 of the present disclosure;

FIG. 25 is a second structural schematic view of the lens mechanism according to Embodiment 9 of the present disclosure;

FIG. 26 is a first partial view of a sight according to an embodiment of the present disclosure;

FIG. 27 is a sectional view taken along line I-I shown in FIG. 26;

FIG. 28 is a second partial view of the sight according to an embodiment of the present disclosure; and

FIG. 29 is a sectional view taken along line J-J shown in FIG. 28.

REFERENCE NUMERALS

1. main objective lens set; 2. eyepiece set; 3. switching assembly; 4. reticle; 41. pattern surface; 5. night vision assembly; 51. image sensor; 52. display; 6. first compensation lens; 7. second compensation lens; 8. third compensation lens; 9. fourth compensation lens; 10. thermal imaging objective lens set; 11. thermal imaging core; 12. main optical axis; 13. rotating shaft; 14. lens barrel; 15. connecting rotating shaft; 16. avoidance structure; 17. rotating handle; 18. positioning member; 19. positioning elastic member; and 20. bearing.

### DETAILED DESCRIPTION OF THE EMBODIMENTS

The following describes in detail the embodiments of the present disclosure, and the examples of the embodiments are shown in the accompanying drawings. Identical or similar reference numerals represent identical or similar elements or elements having identical or similar functions. The embodiments described below with reference to the accompanying drawings are exemplary, and are intended to explain the present disclosure but should not be construed as a limitation to the present disclosure.

In the description of the present disclosure, it should be understood that orientations or position relationships indicated by terms “length”, “width”, “upper”, “lower”, “front”, “rear”, “left”, “right”, “vertical”, “horizontal”, “top”, “bottom”, “inside”, “outside”, and the like are based on the orientations or position relationships shown in the accompanying drawings. These terms are just used to facilitate the description of the present disclosure and simplify the description, but not to indicate or imply that the mentioned device or elements must have a specific orientation and must be established and operated in a specific orientation, and thus these terms cannot be understood as a limitation to the present disclosure.

In addition, the terms “first” and “second” are merely intended for a purpose of description, and shall not be understood as an indication or implication of relative importance or implicit indication of a quantity of indicated technical features. Thus, features defined with “first” and “second” may explicitly or implicitly include one or more of the features. In the description of the present disclosure, “a plurality of” means two or more, unless otherwise specifically defined.

In the present disclosure, unless otherwise clearly specified, the terms “installation”, “interconnection”, “connection” and “fixation” etc. are intended to be understood in a broad sense. For example, the “connection” may be a fixed connection, removable connection or integral connection; may be a mechanical connection or electrical connection; may be a direct connection or indirect connection using a medium; and may be a communication or interaction between two elements. Those of ordinary skill in the art may understand specific meanings of the above terms in the present disclosure based on a specific situation.

In order to make the objectives, technical solutions, and advantages of the present disclosure more clear, the present disclosure is further described in detail below with reference to the accompanying drawings and examples.

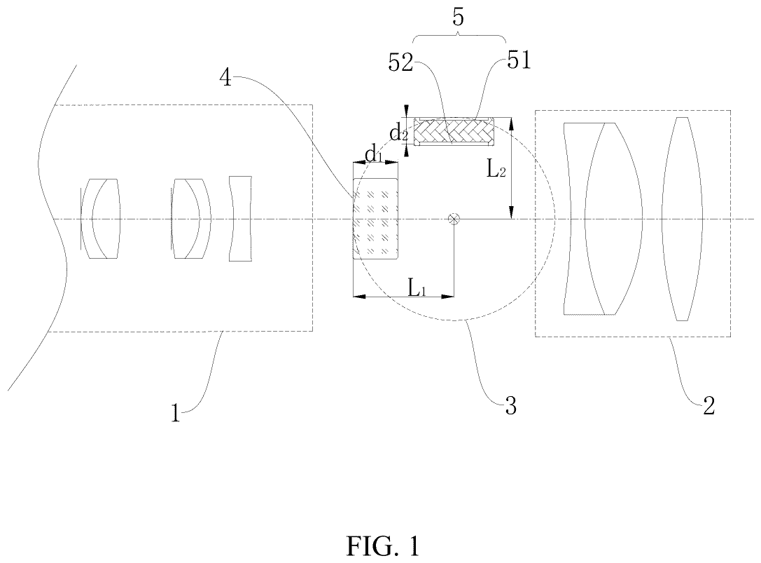

Referring to FIGS. 1 to 4, in an embodiment of the present disclosure, in a first aspect, a lens mechanism is provided. The lens mechanism includes main objective lens set 1, eyepiece set 2, and switching assembly 3. The main objective lens set 1 and the eyepiece set 2 are disposed at an interval along main optical axis 12, and the switching assembly 3 is movably disposed between the main objective lens set 1 and the eyepiece set 2. The switching assembly 3 is provided with reticle 4 and night vision assembly 5, and the switching assembly 3 has a first state and a second state. When the switching assembly 3 is in the first state, the reticle 4 is located on the main optical axis 12 and the night vision assembly 5 deviates from the main optical axis 12. When the switching assembly 3 is in the second state, the night vision assembly 5 is located on the main optical axis 12 and the reticle 4 deviates from the main optical axis 12.

Specifically, the main objective lens set 1 may be a single lens. The main objective lens set 1 may also refer to a lens set composed of a plurality of lenses, and the purpose of combining these lenses is to overcome the imaging defects of a single lens and improve the optical quality of the objective lens. The eyepiece set 2 may be a single lens. The eyepiece set 2 may also refer to a lens set composed of a plurality of lenses, whose function is also to overcome the imaging defects of a single lens and improve the optical quality of the objective lens. The switching assembly 3 refers to a component with a certain volume. The switching assembly 3 may be in a plate shape, a cylinder shape, a column shape, or a combination of various shapes. The switching assembly 3 is movably disposed between the main objective lens set 1 and the eyepiece set 2, and the switching assembly 3 may be movably connected to a lens barrel, where the movement of the switching assembly 3 may be linear motion or rotation about an axis. The first state and the second state refer to two different states of the switching assembly 3 during movement, where the first state and the second state may refer to two spaced positions on a straight line or two spaced positions on an arc, which can be selected according to the movement mode of the switching assembly 3 and will not be repeated herein.

The reticle 4 refers to a light-transmitting component with a certain thickness, and the reticle 4 may be made of high-quality glass or quartz. Its surface is specially treated to have high transparency and hardness, as well as excellent performances such as impact resistance. Various specific marks such as reticle mil lines, scales or degree rings are engraved on the reticle 4, which are configured to aim at and measure an external object, where a surface of the reticle 4 with the marks engraved thereon is pattern surface 41. The night vision assembly 5 refers to an assembly configured to enhance visual ability at night or in low-light environments. Its working principle is to capture light rays through a photoelectric imaging device, convert the light rays into electrical signals and transmit the electrical signals to a display unit, process and enhance the signals during transmission, such that a user can see images, which cannot be seen by the naked eye, through the display unit.

In the lens mechanism provided in the embodiment of the present disclosure, the switching assembly 3 is disposed between the main objective lens set 1 and the eyepiece set 2, and the reticle 4 and the night vision assembly 5 are disposed on the switching assembly 3. The switching assembly 3 is movably disposed between the main objective lens set 1 and the eyepiece set 2, and the switching assembly 3 has a first state and a second state. When the switching assembly 3 is in the first state, the reticle 4 is located on the main optical axis 12 and the night vision assembly 5 deviates from the main optical axis 12. When the switching assembly 3 is in the second state, the night vision assembly 5 is located on the main optical axis 12 and the reticle 4 deviates from the main optical axis 12. Compared with the sight in the prior art, the reticle 4 and the night vision assembly 5 can be driven to move simply by toggling the switching assembly 3 between the first state and the second state, so as to realize rapid switching of the lens mechanism between a white light state and a night vision state. It is not necessary to re-zero the sight when replacing the sight, which also reduces the cost of the sight, and enables easy and quick operation, thereby avoiding the loss of combat opportunities due to delay.

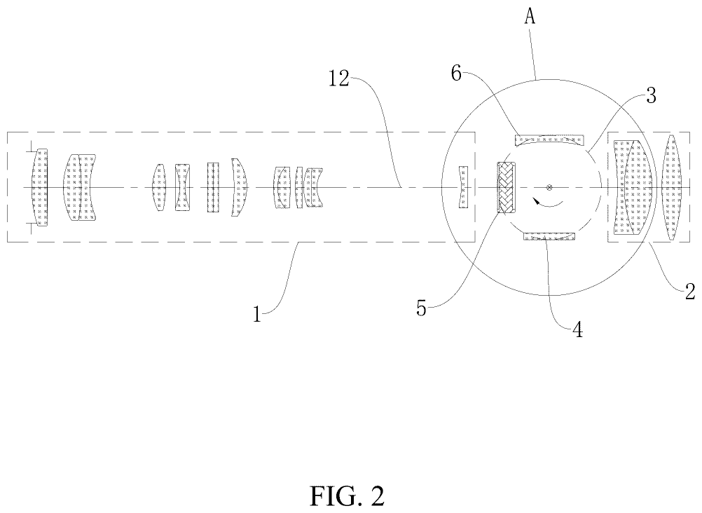

In an embodiment, referring to FIGS. 2 to 5, when the switching assembly 3 is in the first state, the pattern surface 41 of the reticle 4 coincides with an image-side focal plane of the main objective lens set 1. When the switching assembly 3 is in the second state, a light-receiving surface of the night vision assembly 5 coincides with the image-side focal plane of the main objective lens set 1, and a display surface of the night vision assembly 5 coincides with an object-side focal plane of the eyepiece set 2. The lens mechanism further includes first compensation lens 6. The first compensation lens 6 has negative optical power, and the first compensation lens 6 is movable between a first position corresponding to the first state and a second position corresponding to the second state. At the first position, the first compensation lens 6 is located on the main optical axis 12 and between the reticle 4 and the eyepiece set 2, and the first compensation lens 6 is configured to make the object-side focal plane of the eyepiece set 2 coincide with the image-side focal plane of the main objective lens set 1. At the second position, the first compensation lens 6 deviates from the main optical axis 12. Specifically, the first compensation lens 6 refers to an optical element made of a transparent material. The first compensation lens 6 is fabricated in accordance with the law of refraction, and the first compensation lens 6 is made of a glass or acrylic material. The focal length of the optical system can be compensated by disposing the first compensation lens 6. The first position of the first compensation lens 6 refers to the position of the first compensation lens 6 when the switching assembly 3 is in the first state, and the second position of the first compensation lens 6 refers to the position of the first compensation lens 6 when the switching assembly 3 is in the second state.

At present, in the night vision state, for the night vision assembly 5 to form a clear image during operation, it is necessary to make the light-receiving surface of the night vision assembly 5 coincide with the image-side focal plane of the main objective lens set 1, and at the same time make the display surface of the night vision assembly 5 coincide with the object-side focal plane of the eyepiece set 2. However, due to the certain thickness of the night vision assembly 5 itself, there is always a certain distance between the light-receiving surface and the display surface of the night vision assembly 5, which results in a certain distance between the image-side focal plane of the main objective lens set 1 and the object-side focal plane of the eyepiece set 2 along the main optical axis. However, when the sight is switched to the white light state, it is necessary to make both the focal plane of the main objective lens set 1 and the focal plane of the eyepiece set 2 coincide with the pattern surface 41 of the reticle 4 to form a clear image. In order to enable both the night vision mode and the white light mode to form clear images, the currently adopted method is to use reticle 4 with a certain thickness. First, the pattern surface 41 of the reticle 4 coincides with the focal plane of the main objective lens set 1, and then the image-side focal plane of the eyepiece set 2 coincides with the pattern surface 41 of the reticle 4 through the refraction of the reticle 4, so as to achieve the purpose of clear imaging. However, this method requires the reticle 4 to have a large thickness, and an excessively large thickness of the reticle 4 will increase the product weight and cause imaging chromatic aberration to affect the image quality. To solve the above problems, the first compensation lens 6 is added to the lens mechanism in this embodiment. The specific operation process after adding the first compensation lens 6 is as follows.

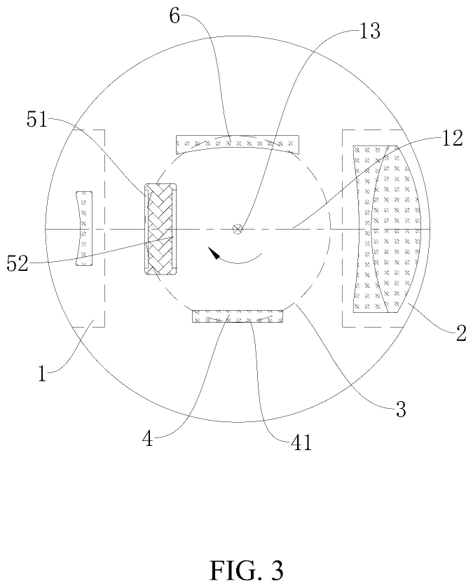

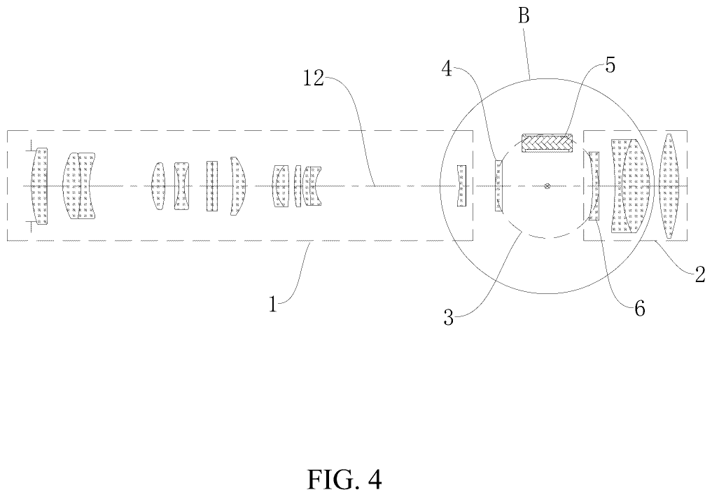

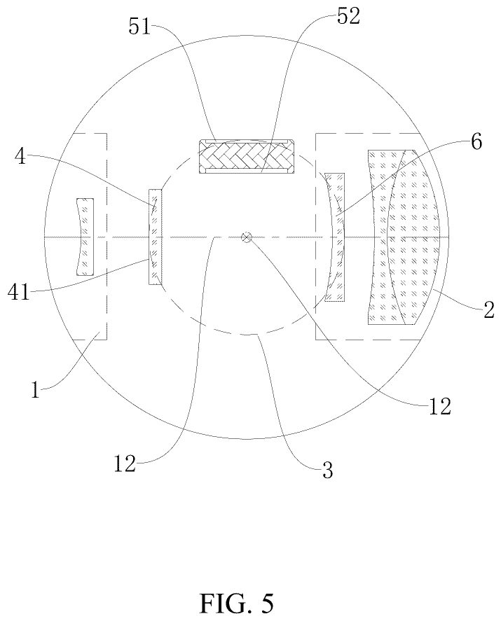

The first compensation lens 6 is movable between the first position corresponding to the first state and the second position corresponding to the second state. As shown in FIGS. 2 and 3, when the switching assembly 3 is in the second state, the first compensation lens 6 is located at the second position and deviates from the main optical axis 12, the night vision assembly 5 is located on the main optical axis 12, the light-receiving surface of the night vision assembly 5 coincides with the image-side focal plane of the main objective lens set 1, the display surface of the night vision assembly 5 coincides with the object-side focal plane of the eyepiece set 2, and a clear image can be formed in the night vision state. As shown in FIGS. 4 and 5, when the switching assembly 3 is in the first state, the first compensation lens 6 is located at the first position and on the main optical axis 12, the reticle 4 is located on the main optical axis 12, the pattern surface 41 of the reticle 4 coincides with the image-side focal plane of the main objective lens set 1, and the object-side focal plane of the eyepiece set 2 coincides with the pattern surface 41 of the reticle 4 under the combined action of the compensation lens and the reticle 4, such that a clear image can also be formed in the white light mode on the premise of ensuring clear imaging in the night vision mode.

When the switching assembly 3 is in the first state, the focal length of the eyepiece set 2 can be increased by disposing the first compensation lens 6, such that the entire lens mechanism can form clear images in both the white light state and the night vision state. Meanwhile, the thickness of the reticle 4 can be reduced, thereby preventing the imaging quality from being affected by imaging chromatic aberration.

In addition, the first compensation lens 6 may be disposed on the switching assembly 3 to move together with the switching assembly 3. Alternatively, the first compensation lens 6 may also be disposed on other movable components and driven to move by other movable components, so as to cooperate with the imaging of the reticle 4. This makes the first compensation lens 6 easy and flexible to operate.

In an embodiment, referring to FIGS. 3 and 5, the first compensation lens 6 is disposed on the switching assembly 3 and is movable together with the switching assembly 3, the first compensation lens 6 is disposed opposite to the reticle 4, and the optical axis of the first compensation lens 6 coincides with the optical axis of the reticle 4. Specifically, by disposing the first compensation lens 6 on the switching assembly 3 such that the first compensation lens 6 is movable together with the reticle 4 and the night vision assembly 5, the sight achieves rapid state switching, and the structure of the lens mechanism is simplified.

In an embodiment, referring to FIGS. 3 and 5, the switching assembly 3 has a degree of freedom to rotate about rotating shaft 13, and the rotating shaft 13 is perpendicular to and intersects with the main optical axis 12. Specifically, the fact that the switching assembly 3 has a degree of freedom to rotate about the rotating shaft 13 means that the switching assembly 3 is rotatable about the rotating shaft 13, and the rotating shaft 13 is perpendicular to and intersects with the main optical axis 12. Meanwhile, the distance between the light-receiving surface of the night vision assembly 5 and the rotating shaft 13 is a first distance, the distance between the pattern surface 41 of the reticle 4 and the rotating shaft 13 is a second distance, and the first distance is equal to the second distance. After the position of the rotating shaft 13 of the switching assembly 3 is determined, when the switching assembly 3 rotates about the rotating shaft 13 to the first state, the pattern surface 41 of the reticle 4 coincides with the image-side focal plane of the main objective lens set 1. Since the first distance is equal to the second distance, when the switching assembly 3 rotates about the rotating shaft 13 to the second state, the light-receiving surface of the night vision assembly 5 will also coincide with the image-side focal plane of the main objective lens set 1. The switching assembly 3 adopts a rotating mounting mode, which can adjust the positions of the night vision assembly 5 and the reticle 4 through its own movement and save the space occupied by the switching assembly 3 during movement.

In an optional embodiment, referring to FIGS. 3 and 5, the first compensation lens 6 is a negative optical power lens, and the negative optical power lens is configured to increase the focal length of the eyepiece set 2. Specifically, optical power is a parameter describing the light focusing ability of a lens or an optical system in optics, and a negative optical power lens refers to a lens structure capable of diverging light rays. The negative optical power lens may be a negative lens, an aspheric lens, a diffractive lens, etc., and the body of the negative optical power lens may be made of materials with high light transmittance and good optical performance such as glass, quartz or acrylic. The focal length of the eyepiece set 2 can be effectively increased by disposing the first compensation lens 6, such that the sight can form a clear image with the assistance of the first compensation lens 6.

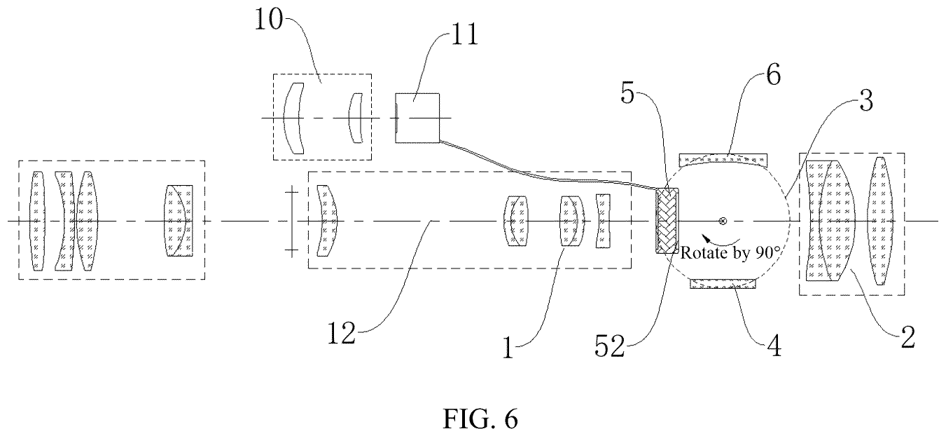

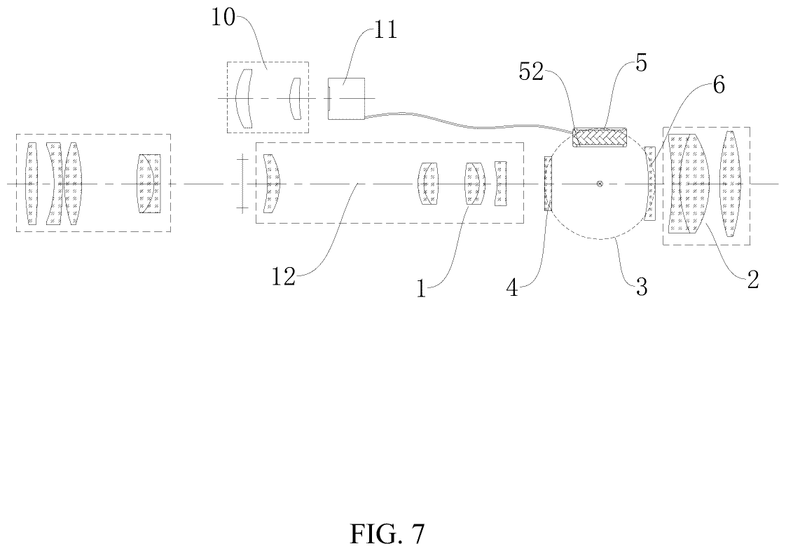

On the basis of the above technical feature of the first compensation lens 6, referring to FIGS. 6 and 7, the night vision assembly 5 includes image sensor 51 and display 52, and the lens mechanism further includes thermal imaging objective lens set 10 and thermal imaging core 11. The thermal imaging core 11 includes a detector and a signal processing unit. The detector is electrically connected to the signal processing unit, and the signal processing unit is electrically connected to the display 52. Specifically, the image sensor 51 is configured to receive a light ray, convert the light ray into an electrical signal, and send the electrical signal to the display 52. The display 52 is configured to display an image. The image sensor 51 may be complementary metal-oxide semiconductor (CMOS) image sensor 51 or another type of detector. A light-receiving surface of the image sensor 51 serves as the light-receiving surface of the entire night vision assembly 5, and a light-emitting surface of the display 52 serves as the display surface of the entire night vision assembly 5. The image sensor 51 and the display 52 form the night vision assembly 5. The image sensor 51 captures the light ray and converts it into an electrical signal. The electrical signal is processed and enhanced and sent to the display 52. The processed signal is displayed through the display 52, such that a user can see an image that cannot be seen by the naked eye, thereby enhancing the visual ability of the user in low-light environments.

In addition, the lens mechanism further includes thermal imaging objective lens set 10 and thermal imaging core 11. The thermal imaging core 11 includes a detector and a signal processing unit. The detector is electrically connected to the signal processing unit, and the signal processing unit is electrically connected to the display 52. Specifically, the thermal imaging objective lens set 10 may be a single lens, or may refer to a lens set composed of a plurality of lenses. The thermal imaging objective lens set 10 and the thermal imaging core 11 are sequentially disposed along a straight line parallel to the main optical axis 12. Since the detector of the thermal imaging core 11 can identify light waves with a wavelength of 8 μm to 14 μm and the lens material suitable for transmitting light waves of this wavelength is different from that for visible light waves, the thermal imaging core 11 and the night vision assembly 5 cannot share the objective lens set. Therefore, separate thermal imaging objective lens set 10 needs to be provided. By disposing the thermal imaging objective lens set 10 and the thermal imaging core 11 sequentially along a straight line parallel to the main optical axis 12, the user can aim in both the white light mode and the thermal imaging night vision mode, and the target image information acquired by the main objective lens set 1 and the thermal imaging objective lens set 10 is consistent. In this way, the lens mechanism is easy to operate.

The thermal imaging core 11 includes the detector and the signal processing unit. The detector is disposed on one end of the signal processing unit close to the thermal imaging objective lens set 10 and is electrically connected to the signal processing unit, and the signal processing unit is electrically connected to the display 52. Specifically, the detector is configured to acquire heat information and transmit the heat information to the signal processing unit. The signal processing unit converts the heat information into digital information and sends the digital information to the display 52. The display 52 converts the digital information into visual image information. When the switching assembly 3 is in the second state, the user can see the image on the display 52 through the eyepiece set 2, such that the user can aim in the thermal imaging night vision mode.

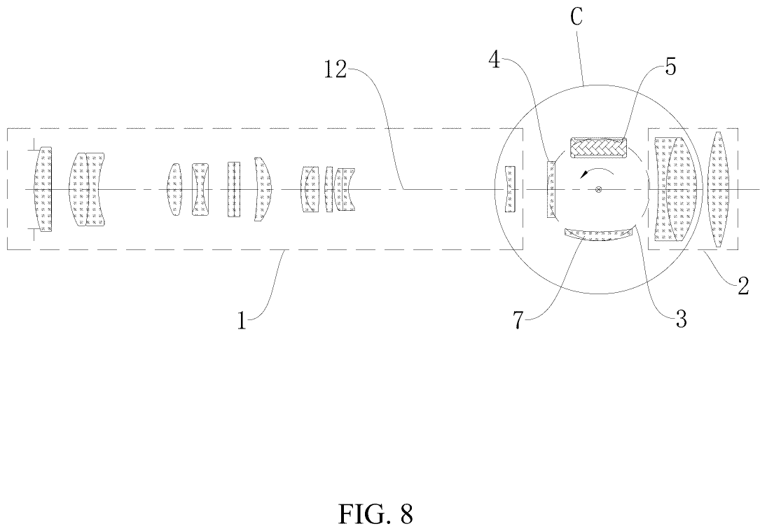

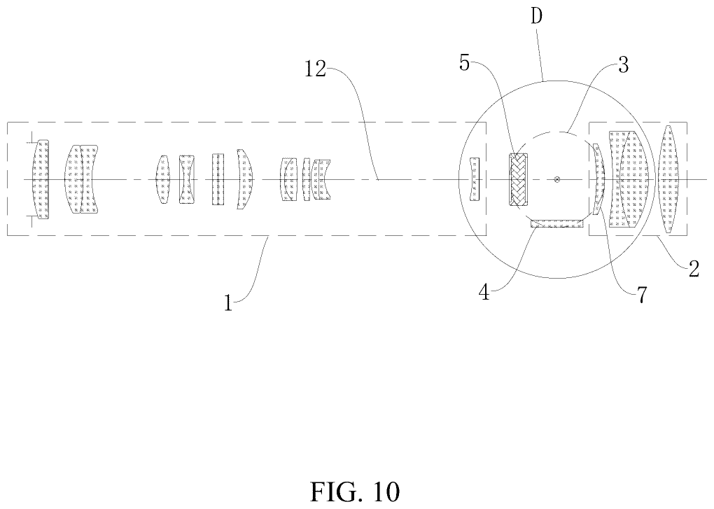

In another embodiment, referring to FIGS. 8 to 11, when the switching assembly 3 is in the first state, the image-side focal plane of the main objective lens set 1 coincides with the pattern surface 41 of the reticle 4, and the object-side focal plane of the eyepiece set 2 also coincides with the pattern surface 41 of the reticle 4. When the switching assembly 3 is in the second state, the light-receiving surface of the night vision assembly 5 coincides with the image-side focal plane of the main objective lens set 1. The lens mechanism includes second compensation lens 7. The second compensation lens 7 has positive optical power, and the second compensation lens 7 is movable between a third position corresponding to the first state and a fourth position corresponding to the second state. At the fourth position, the second compensation lens 7 is located on the main optical axis 12 and between the night vision assembly 5 and the eyepiece set 2, such that when the switching assembly 3 is in the second state, the light-receiving surface of the night vision assembly 5 coincides with the image-side focal plane of the main objective lens set 1, and the display surface of the night vision assembly 5 coincides with the object-side focal plane of the eyepiece set 2. At the third position, the second compensation lens 7 deviates from the main optical axis 12. Specifically, the second compensation lens 7 refers to an optical element made of a transparent material. The second compensation lens 7 is fabricated in accordance with the law of refraction, and the second compensation lens 7 may be made of glass, crystal, acrylic or other materials. Meanwhile, the third position of the second compensation lens 7 refers to the position of the second compensation lens 7 when the switching assembly 3 is in the first state, and the fourth position of the second compensation lens 7 refers to the position of the second compensation lens 7 when the switching assembly 3 is in the second state.

At present, in the white light state, in order to form a clear image, it is necessary to make the pattern surface 41 of the reticle 4 coincide with both the image-side focal plane of the main objective lens set 1 and the object-side focal plane of the eyepiece set 2. However, when switching to the night vision state, due to the certain thickness of the night vision assembly 5 itself, there is a certain distance between the light-receiving surface and the display surface of the night vision assembly 5. Thus, when the image-side focal plane of the main objective lens set 1 coincides with the light-receiving surface of the night vision assembly 5, the object-side focal plane of the eyepiece set 2 cannot coincide with the display surface of the night vision assembly 5, thereby affecting the clarity of the formed image. To solve the above problems, the second compensation lens 7 is added to the lens mechanism in this embodiment. The specific operation process of the lens mechanism after adding the second compensation lens 7 is as follows.

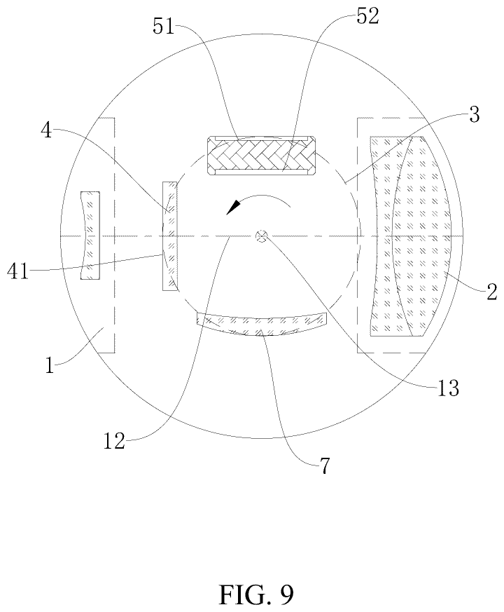

The second compensation lens 7 is movable between the third position corresponding to the first state and the fourth position corresponding to the second state. As shown in FIGS. 8 to 11, when the switching assembly 3 is in the first state, the second compensation lens 7 is located at the third position and deviates from the main optical axis 12, the reticle 4 is located on the main optical axis 12, the pattern surface 41 of the reticle 4 coincides with both the image-side focal plane of the main objective lens set 1 and the object-side focal plane of the eyepiece set 2, and the sight can form a clear image in the white light state. As shown in FIGS. 8 and 9, when the switching assembly 3 is in the second state, the second compensation lens 7 is located at the fourth position and on the main optical axis 12, the night vision assembly 5 is located on the main optical axis 12, the light-receiving surface of the night vision assembly 5 coincides with the image-side focal plane of the main objective lens set 1, and the object-side focal plane of the eyepiece set 2 coincides with the display surface of the night vision assembly 5 under the action of the compensation lens, such that the sight can form a clear image in the night vision mode on the premise of ensuring clear imaging in the white light mode.

When the switching assembly 3 is in the second state, the focal length of the eyepiece set 2 can be shortened by disposing the second compensation lens 7, such that the entire lens mechanism can form clear images in both the white light state and the night vision state. Meanwhile, the thickness of the reticle 4 can be reduced, thereby preventing the imaging quality from being affected by imaging chromatic aberration.

It should be noted that the second compensation lens 7 is movably disposed on the lens mechanism. The second compensation lens 7 may be disposed on the switching assembly 3 to move together with the switching assembly 3. Alternatively, the second compensation lens 7 may be disposed on other components and driven to move by other components to cooperate with the imaging of the night vision assembly 5.

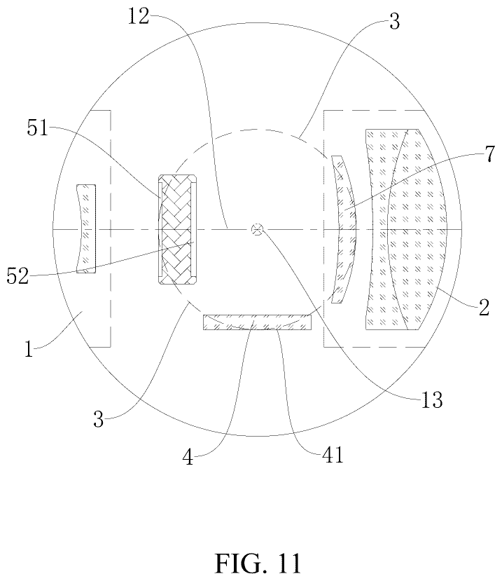

In an embodiment, referring to FIGS. 9 and 11, the second compensation lens 7 is disposed on the switching assembly 3 and is movable together with the switching assembly 3, the second compensation lens 7 is disposed opposite to the night vision assembly 5, and the optical axis of the second compensation lens 7 coincides with the optical axis of the night vision assembly 5. Specifically, by disposing the second compensation lens 7 on the switching assembly 3 such that the second compensation lens 7 is movable together with the reticle 4 and the night vision assembly 5, the sight achieves rapid state switching, and the structure of the lens mechanism is simplified.

In an embodiment, referring to FIGS. 9 and 11, the switching assembly 3 has a degree of freedom to rotate about rotating shaft 13, and the rotating shaft 13 is perpendicular to and intersects with the main optical axis 12. Specifically, the fact that the switching assembly 3 has a degree of freedom to rotate about the rotating shaft 13 means that the switching assembly 3 is rotatable about the rotating shaft 13, and the rotating shaft 13 is perpendicular to and intersects with the main optical axis 12. Meanwhile, the distance between the light-receiving surface of the night vision assembly 5 and the rotating shaft 13 is a first distance, the distance between the pattern surface 41 of the reticle 4 and the rotating shaft 13 is a second distance, and the first distance is equal to the second distance. After the position of the rotating shaft 13 of the switching assembly 3 is determined, when the switching assembly 3 rotates about the rotating shaft 13 to the first state, the pattern surface 41 of the reticle 4 coincides with the image-side focal plane of the main objective lens set 1. Since the first distance is equal to the second distance, when the switching assembly 3 rotates about the rotating shaft 13 to the second state, the light-receiving surface of the night vision assembly 5 will also coincide with the image-side focal plane of the main objective lens set 1. The switching assembly 3 adopts a rotating mounting mode. It can adjust the positions of the night vision assembly 5 and the reticle 4 through its own movement, and save the space occupied by the switching assembly 3 during movement, thereby reducing the overall volume of the lens mechanism and lowering the cost of the sight.

In an optional embodiment, referring to FIGS. 9 and 11, the second compensation lens 7 is a positive optical power lens, and the positive optical power lens is configured to reduce the focal length of the eyepiece set 2. Specifically, optical power is a parameter describing the light focusing ability of a lens or an optical system in optics, and a positive optical power lens refers to a lens structure capable of converging light rays. The positive optical power lens may be a positive lens, an aspheric lens, a diffractive lens, etc., and the body of the positive optical power lens may be made of materials with high light transmittance and good optical performance such as glass, quartz or acrylic. The focal length of the eyepiece set 2 can be effectively shortened by disposing the second compensation lens 7, such that the lens mechanism can form clear images with the assistance of the second compensation lens 7, thereby making the sight easy to operate.

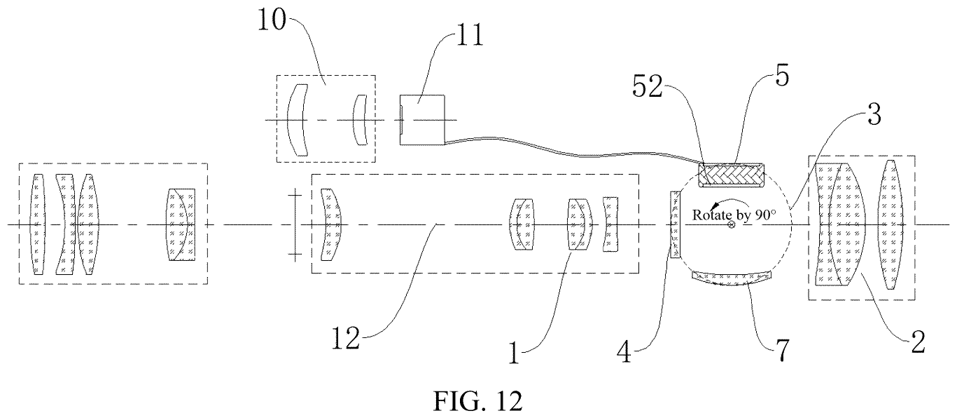

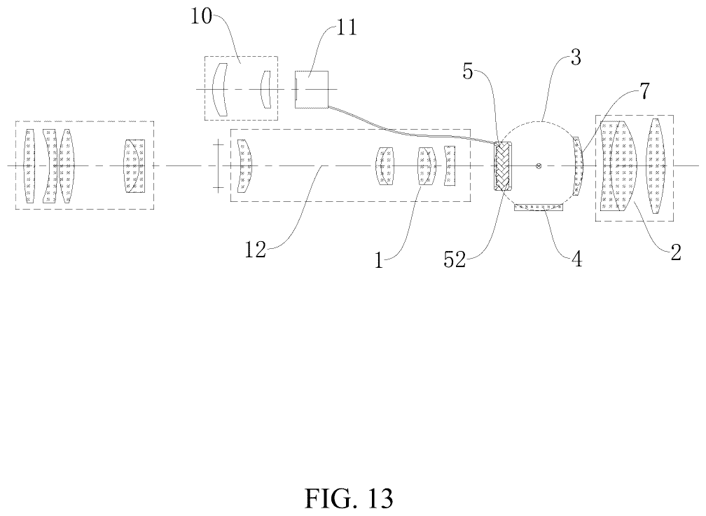

On the basis of the above technical feature of the second compensation lens 7, referring to FIGS. 12 and 13, the night vision assembly 5 includes image sensor 51 and display 52, and the lens mechanism further includes thermal imaging objective lens set 10 and thermal imaging core 11. The thermal imaging core 11 includes a detector and a signal processing unit. The detector is electrically connected to the signal processing unit, and the signal processing unit is electrically connected to the display 52. Specifically, the image sensor 51 is configured to receive a light ray, convert the light ray into an electrical signal, and send the electrical signal to the display 52. The display 52 is configured to display an image. The image sensor 51 may be CMOS image sensor 51 or another type of detector. A light-receiving surface of the image sensor 51 serves as the light-receiving surface of the entire night vision assembly 5, and a light-emitting surface of the display 52 serves as the display surface of the entire night vision assembly 5. The image sensor 51 and the display 52 form the night vision assembly 5. The image sensor 51 captures the light ray and converts it into an electrical signal. The electrical signal is processed and enhanced and sent to the display 52. The processed signal is displayed through the display 52, such that a user can see an image that cannot be seen by the naked eye, thereby enhancing the visual ability of the user at night or in low-light environments.

In addition, the lens mechanism further includes thermal imaging objective lens set 10 and thermal imaging core 11. The thermal imaging core 11 includes a detector and a signal processing unit. The detector is electrically connected to the signal processing unit, and the signal processing unit is electrically connected to the display 52. Specifically, the thermal imaging objective lens set 10 may be a single lens, or may refer to a lens set composed of a plurality of lenses. The thermal imaging objective lens set 10 and the thermal imaging core 11 are sequentially disposed along a straight line parallel to the main optical axis 12. Since the detector of the thermal imaging core 11 can identify light waves with a wavelength of 8 μm to 14 μm and the lens material suitable for transmitting light waves of this wavelength is different from that for visible light waves, the thermal imaging core 11 and the night vision assembly 5 cannot share the objective lens set. Therefore, separate thermal imaging objective lens set 10 needs to be provided. By disposing the thermal imaging objective lens set 10 and the thermal imaging core 11 sequentially along a straight line parallel to the main optical axis 12, the user can aim in both the white light mode and the thermal imaging night vision mode, and the target image information acquired by the main objective lens set 1 and the thermal imaging objective lens set 10 is consistent. In this way, the night vision effect of the lens mechanism is improved.

The thermal imaging core 11 includes the detector and the signal processing unit. The detector is disposed on one end of the signal processing unit close to the thermal imaging objective lens set 10 and is electrically connected to the signal processing unit, and the signal processing unit is electrically connected to the display 52. Specifically, the detector is configured to acquire heat information and transmit the heat information to the signal processing unit. The signal processing unit converts the heat information into digital information and sends the digital information to the display 52. The display 52 converts the digital information into visual image information. When the switching assembly 3 is in the second state, the user can see the image on the display 52 through the eyepiece set 2, such that the user can aim in the thermal imaging night vision mode.

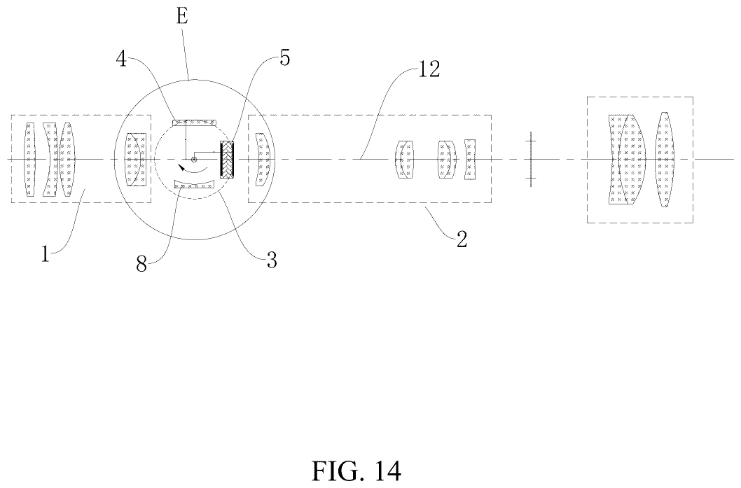

In an embodiment, referring to FIGS. 14 to 17, when the switching assembly 3 is in the first state, the pattern surface 41 of the reticle 4 coincides with the object-side focal plane of the eyepiece set 2. When the switching assembly 3 is in the second state, the light-receiving surface of the night vision assembly 5 coincides with the image-side focal plane of the main objective lens set 1, and the display surface of the night vision assembly 5 coincides with the object-side focal plane of the eyepiece set 2. The lens mechanism further includes third compensation lens 8, and the third compensation lens 8 is movable between a fifth position corresponding to the first state and a sixth position corresponding to the second state. At the fifth position, the third compensation lens 8 is located on the main optical axis 12 and between the reticle 4 and the main objective lens set 1, and the third compensation lens 8 is configured to make the object-side focal plane of the eyepiece set 2 coincide with the image-side focal plane of the main objective lens set 1. At the sixth position, the third compensation lens 8 deviates from the main optical axis 12. Specifically, the third compensation lens 8 refers to an optical element made of a transparent material. The third compensation lens 8 is fabricated in accordance with the law of refraction, and the third compensation lens 8 is made of glass or acrylic material. The focal length of the optical system can be compensated by disposing the third compensation lens 8. The fifth position of the third compensation lens 8 refers to the position of the third compensation lens 8 when the switching assembly 3 is in the first state. The sixth position of the third compensation lens 8 refers to the position of the third compensation lens 8 when the switching assembly 3 is in the second state.

At present, in the night vision state, for the night vision assembly 5 to form a clear image during operation, it is necessary to make the light-receiving surface of the night vision assembly 5 coincide with the image-side focal plane of the main objective lens set 1, and at the same time make the display surface of the night vision assembly 5 coincide with the object-side focal plane of the eyepiece set 2. However, due to the certain thickness of the night vision assembly 5 itself, there is always a certain distance between the light-receiving surface and the display surface of the night vision assembly 5, which results in a certain distance between the image-side focal plane of the main objective lens set 1 and the object-side focal plane of the eyepiece set 2 along the main optical axis 12. However, when the sight is switched to the white light state, it is necessary to make both the focal plane of the main objective lens set 1 and the focal plane of the eyepiece set 2 coincide with the pattern surface 41 of the reticle 4 to form a clear image. In order to enable both the night vision mode and the white light mode to form clear images, the currently adopted method is to use reticle 4 with a certain thickness. First, the pattern surface 41 of the reticle 4 coincides with the object-side focal plane of the eyepiece set 2, and then the image-side focal plane of the main objective lens set 1 coincides with the pattern surface 41 of the reticle 4 through the refraction of the reticle 4, so as to achieve the purpose of clear imaging. However, this method requires the reticle 4 to have a large thickness, and an excessively large thickness of the reticle 4 will increase the product weight and cause imaging chromatic aberration to affect the image quality. To solve the above problems, the third compensation lens is added to the lens mechanism in this embodiment. The specific operation process after adding the third compensation lens is as follows.

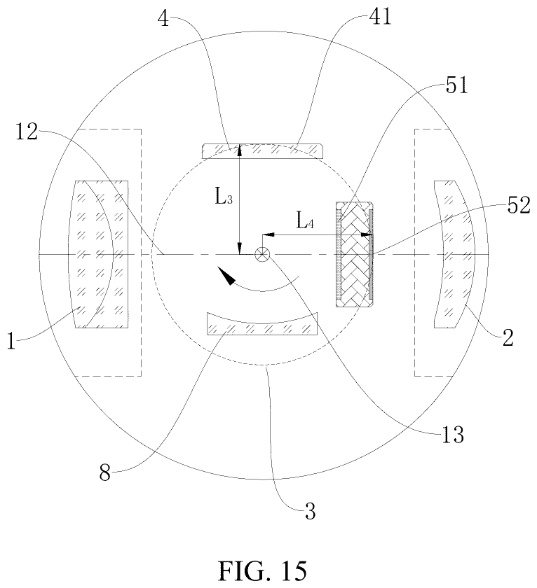

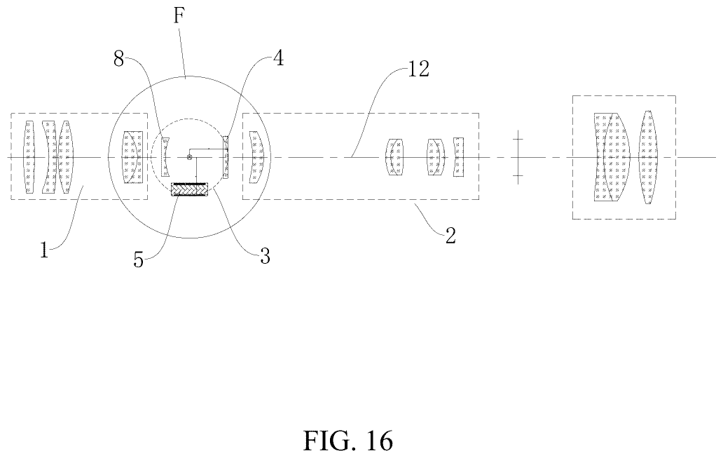

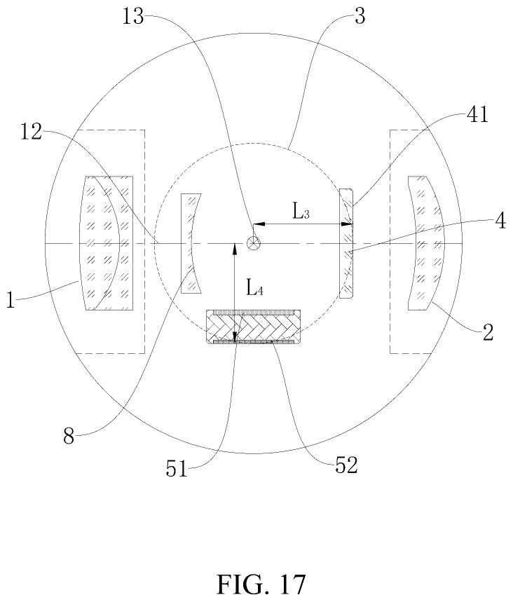

The third compensation lens 8 is movable between the fifth position corresponding to the first state and the sixth position corresponding to the second state. As shown in FIGS. 14 and 15, when the switching assembly 3 is in the second state, the third compensation lens is located at the sixth position and deviates from the main optical axis 12, the night vision assembly 5 is located on the main optical axis 12, the light-receiving surface of the night vision assembly 5 coincides with the image-side focal plane of the main objective lens set 1, the display surface of the night vision assembly 5 coincides with the object-side focal plane of the eyepiece set 2, and a clear image can be formed in the night vision state. As shown in FIGS. 16 and 17, when the switching assembly 3 is in the first state, the third compensation lens 8 is located at the fifth position and on the main optical axis 12, the reticle 4 is also located on the main optical axis 12, the pattern surface 41 of the reticle 4 coincides with the object-side focal plane of the eyepiece set, and the image-side focal plane of the main objective lens set 1 also coincides with the pattern surface 41 of the reticle 4 under the combined action of the compensation lens and the reticle 4, such that a clear image can be formed in the white light mode on the premise of ensuring clear imaging in the night vision mode.

When the switching assembly 3 is in the first state, the focal length of the main objective lens set 1 can be increased by disposing the third compensation lens 8, such that the entire lens mechanism can form clear images in both the white light state and the night vision state. Meanwhile, the thickness of the reticle 4 can be reduced, thereby preventing the imaging quality from being affected by imaging chromatic aberration.

In addition, the third compensation lens 8 may be disposed on the switching assembly 3 to move together with the switching assembly 3. Alternatively, the third compensation lens 8 may also be disposed on other movable components and driven to move by other movable components, so as to cooperate with the imaging of the reticle 4. Thus, the third compensation lens 8 is easy and flexible to operate.

In an optional embodiment, referring to FIGS. 15 and 17, the third compensation lens 8 is a negative optical power lens, and the negative optical power lens is configured to increase the focal length of the main objective lens set 1. Specifically, optical power is a parameter describing the light focusing ability of a lens or an optical system in optics, and a negative optical power lens refers to a lens structure capable of diverging light rays. The negative optical power lens may be a negative lens, an aspheric lens, a diffractive lens, etc., and the body of the negative optical power lens may be made of materials with high light transmittance and good optical performance such as glass, quartz or acrylic. The focal length of the main objective lens set 1 can be effectively increased by disposing the third compensation lens 8, such that the lens mechanism can form clear images with the assistance of the third compensation lens 8, thereby improving the imaging clarity of the sight.

In an embodiment, referring to FIGS. 15 and 17, the third compensation lens 8 is disposed on the switching assembly 3 and is movable together with the switching assembly 3, the third compensation lens 8 is disposed opposite to the reticle 4, and the optical axis of the third compensation lens 8 coincides with the optical axis of the reticle 4. Specifically, by disposing the third compensation lens 8 on the switching assembly 3 and disposing the third compensation lens 8 opposite to the reticle 4 such that the third compensation lens 8 is movable together with the reticle 4, the sight achieves rapid state switching.

In an embodiment, referring to FIGS. 15 and 17, the switching assembly 3 has a degree of freedom to rotate about rotating shaft 13, and the rotating shaft 13 is perpendicular to and intersects with the main optical axis 12. Specifically, the fact that the switching assembly 3 has a degree of freedom to rotate about the rotating shaft 13 means that the switching assembly 3 is rotatable about the rotating shaft 13, and the rotating shaft 13 is perpendicular to and intersects with the main optical axis 12. Meanwhile, the distance between the display surface of the night vision assembly 5 and the rotating shaft 13 is a first distance, the distance between the pattern surface 41 of the reticle 4 and the rotating shaft 13 is a second distance, and the first distance is equal to the second distance. After the positions of the switching assembly 3 and the rotating shaft 13 are determined, when the switching assembly 3 rotates about the rotating shaft 13 to the first state, the pattern surface 41 of the reticle 4 coincides with the object-side focal plane of the eyepiece set 2. Since the first distance is equal to the second distance, when the switching assembly 3 rotates about the rotating shaft 13 to the second state, the display surface of the night vision assembly 5 will also coincide with the object-side focal plane of the eyepiece set 2. In addition, the switching assembly 3 adopts a rotating mounting mode. It can adjust the positions of the night vision assembly 5, the third compensation lens 8, and the reticle 4 through its own rotation, and save the space occupied by the switching assembly 3 during movement, thereby reducing the overall volume of the lens mechanism and lowering the manufacturing cost of the sight.

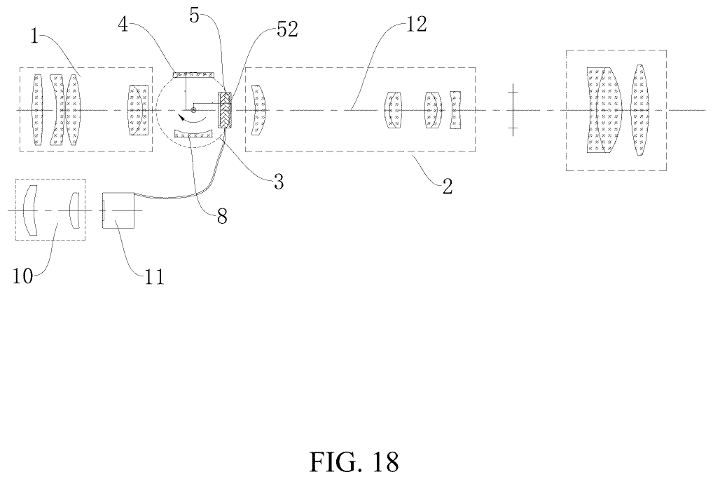

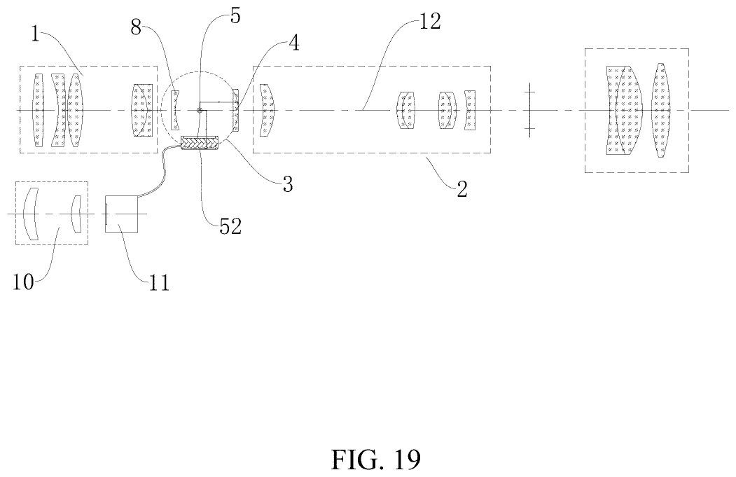

On the basis of the above technical feature of the third compensation lens 8, referring to FIGS. 18 and 19, the night vision assembly 5 includes image sensor 51 and display 52, and the lens mechanism further includes thermal imaging objective lens set 10 and thermal imaging core 11. The thermal imaging core 11 includes a detector and a signal processing unit. The detector is electrically connected to the signal processing unit, and the signal processing unit is electrically connected to the display 52. Specifically, the image sensor 51 is configured to receive a light ray, convert the light ray into an electrical signal, and send the electrical signal to the display 52. The display 52 is configured to display an image. The image sensor 51 may be CMOS image sensor 51 or another type of detector. A light-receiving surface of the image sensor 51 serves as the light-receiving surface of the entire night vision assembly 5, and a light-emitting surface of the display 52 serves as the display surface of the entire night vision assembly 5. The image sensor 51 and the display 52 form the night vision assembly 5. The image sensor 51 captures the light ray and converts it into an electrical signal. The electrical signal is processed and enhanced and sent to the display 52. The processed signal is displayed through the display 52, such that a user can see an image that cannot be seen by the naked eye, thereby enhancing the visual ability of the user at night or in low-light environments.

In addition, the lens mechanism further includes thermal imaging objective lens set 10 and thermal imaging core 11. The thermal imaging core 11 includes a detector and a signal processing unit. The detector is electrically connected to the signal processing unit, and the signal processing unit is electrically connected to the display 52. Specifically, the thermal imaging objective lens set 10 may be a single lens, or may refer to a lens set composed of a plurality of lenses. The thermal imaging objective lens set 10 and the thermal imaging core 11 are sequentially disposed along a straight line parallel to the main optical axis 12. Since the detector of the thermal imaging core 11 can identify light waves with a wavelength of 8 μm to 14 μm and the lens material suitable for transmitting light waves of this wavelength is different from that for visible light waves, the thermal imaging core 11 and the night vision assembly 5 cannot share the objective lens set. Therefore, separate thermal imaging objective lens set 10 needs to be provided. By disposing the thermal imaging objective lens set 10 and the thermal imaging core 11 sequentially along a straight line parallel to the main optical axis 12, the user can aim in both the white light mode and the thermal imaging night vision mode, and the target image information acquired by the main objective lens set 1 and the thermal imaging objective lens set 10 is consistent. The thermal imaging core 11 includes the detector and the signal processing unit. The detector is disposed on one end of the signal processing unit close to the thermal imaging objective lens set 10 and is electrically connected to the signal processing unit, and the signal processing unit is electrically connected to the display 52. Specifically, the detector is configured to acquire heat information and transmit the heat information to the signal processing unit. The signal processing unit converts the heat information into digital information and sends the digital information to the display 52. The display 52 converts the digital information into visual image information. When the switching assembly 3 is in the second state, the user can see the image on the display 52 through the eyepiece set 2 in the thermal imaging night vision mode.

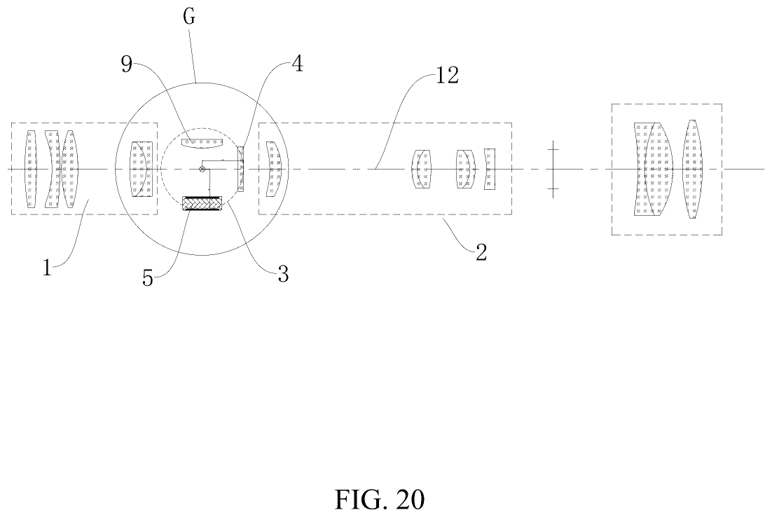

In an embodiment, referring to FIGS. 20 to 23, when the switching assembly 3 is in the first state, the image-side focal plane of the main objective lens set 1 coincides with the pattern surface 41 of the reticle 4, and the object-side focal plane of the eyepiece set 2 also coincides with the pattern surface 41 of the reticle 4. When the switching assembly 3 is in the second state, the display surface of the night vision assembly 5 coincides with the object-side focal plane of the eyepiece set 2. The lens mechanism includes fourth compensation lens 9, and the optical axis of the fourth compensation lens 9 coincides with the optical axis of the night vision assembly 5. The fourth compensation lens 9 is movable between a seventh position corresponding to the first state and an eighth position corresponding to the second state. At the eighth position, the fourth compensation lens 9 is located on the main optical axis 12 and between the night vision assembly 5 and the main objective lens set 1, such that when the switching assembly 3 is in the second state, the display surface of the night vision assembly 5 coincides with the image-side focal plane of the main objective lens set 1. At the seventh position, the fourth compensation lens 9 deviates from the main optical axis 12. Specifically, the fourth compensation lens 9 refers to an optical element made of a transparent material. The fourth compensation lens 9 is fabricated in accordance with the law of refraction, and the fourth compensation lens 9 may be made of glass, crystal, acrylic or other materials. Meanwhile, the seventh position of the fourth compensation lens 9 refers to the position of the fourth compensation lens 9 when the switching assembly 3 is in the first state, and the eighth position of the fourth compensation lens 9 refers to the position of the fourth compensation lens 9 when the switching assembly 3 is in the second state.

At present, in the white light state, in order to form a clear image, it is necessary to make the pattern surface 41 of the reticle 4 coincide with both the image-side focal plane of the main objective lens set 1 and the object-side focal plane of the eyepiece set 2. However, when the lens mechanism is switched to the night vision state, due to the certain thickness of the night vision assembly 5 itself, there is a certain distance between the light-receiving surface and the display surface of the night vision assembly 5. Thus, when the object-side focal plane of the eyepiece set 2 coincides with the display surface of the night vision assembly 5, the image-side focal plane of the main objective lens set 1 cannot coincide with the light-receiving surface of the night vision assembly 5, thereby affecting the clarity of imaging in the night vision state. To solve the above problems, the fourth compensation lens 9 is added to the lens mechanism in this embodiment. The specific operation process after adding the fourth compensation lens 9 is as follows.

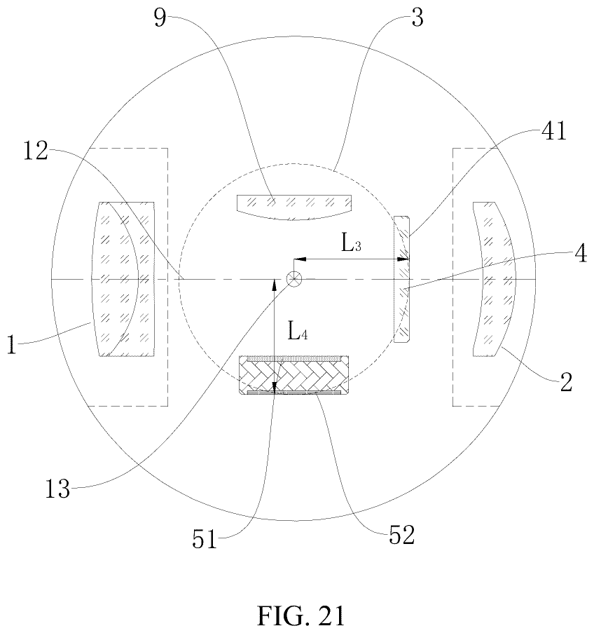

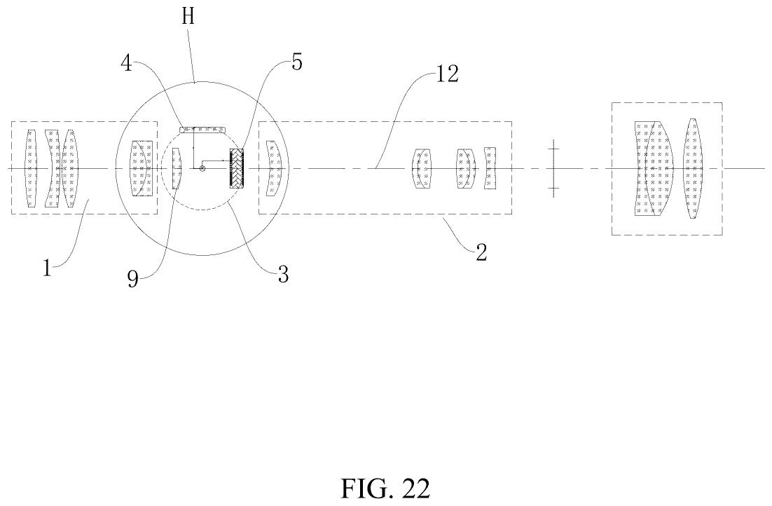

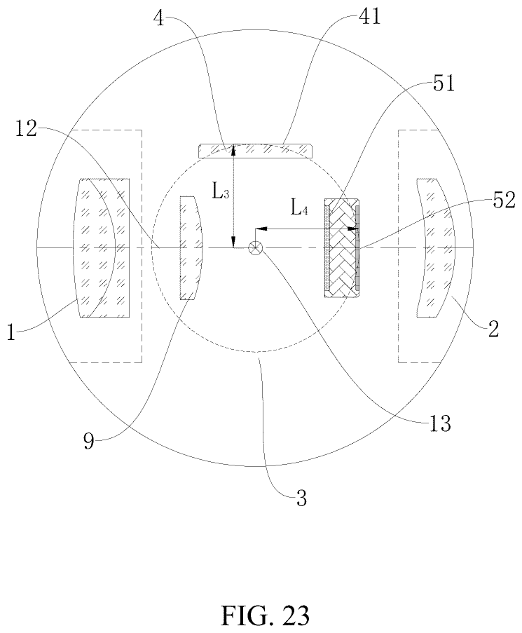

The fourth compensation lens 9 is movable between the seventh position corresponding to the first state and the eighth position corresponding to the second state. As shown in FIGS. 20 and 21, when the switching assembly 3 is in the first state, the fourth compensation lens 9 is located at the seventh position and deviates from the main optical axis 12, the reticle 4 is located on the main optical axis 12, the pattern surface 41 of the reticle 4 coincides with both the image-side focal plane of the main objective lens set 1 and the object-side focal plane of the eyepiece set 2, and the sight can form a clear image in the white light state. As shown in FIGS. 22 and 23, when the switching assembly 3 is in the second state, the fourth compensation lens 9 is located at the eighth position and on the main optical axis 12, the night vision assembly 5 is also located on the main optical axis 12, the display surface of the night vision assembly 5 coincides with the object-side focal plane of the eyepiece set 2, and the image-side focal plane of the main objective lens set 1 coincides with the light-receiving surface of the night vision assembly 5 under the action of the fourth compensation lens 9, such that the sight can form a clear image in the night vision mode on the premise of ensuring clear imaging in the white light mode.

When the switching assembly 3 is in the second state, the focal length of the main objective lens set 1 can be shortened by disposing the fourth compensation lens 9, such that the entire lens mechanism can form clear images in both the white light state and the night vision state. Meanwhile, the thickness of the reticle 4 can be reduced, thereby preventing the imaging quality from being affected by imaging chromatic aberration.

It should be noted that the fourth compensation lens 9 is movably disposed on the lens mechanism. The fourth compensation lens 9 may be disposed on the switching assembly 3 to move together with the switching assembly 3. Alternatively, the fourth compensation lens 9 may also be disposed on other components and driven to move by other components to cooperate with the imaging of the night vision assembly 5.

In an embodiment, referring to FIGS. 21 and 23, the fourth compensation lens 9 is disposed on the switching assembly 3 and is movable together with the switching assembly 3, the fourth compensation lens 9 is disposed opposite to the night vision assembly 5, and the optical axis of the fourth compensation lens 9 coincides with the optical axis of the night vision assembly 5. Specifically, by disposing the fourth compensation lens 9 on the switching assembly 3 such that the fourth compensation lens 9 is movable together with the reticle 4 and the night vision assembly 5, the sight achieves rapid state switching, and the structure of the lens mechanism is simplified.

In an embodiment, referring to FIGS. 21 and 23, the switching assembly 3 has a degree of freedom to rotate about rotating shaft 13, and the rotating shaft 13 is perpendicular to and intersects with the main optical axis 12. Specifically, the fact that the switching assembly 3 has a degree of freedom to rotate about the rotating shaft 13 means that the switching assembly 3 is rotatable about the rotating shaft 13, and the rotating shaft 13 is perpendicular to and intersects with the main optical axis 12. Meanwhile, the distance between the display surface of the night vision assembly 5 and the rotating shaft 13 is a first distance, the distance between the pattern surface 41 of the reticle 4 and the rotating shaft 13 is a second distance, and the first distance is equal to the second distance. After the positions of the switching assembly 3 and the rotating shaft 13 are determined, when the switching assembly 3 rotates about the rotating shaft 13 to the first state, the pattern surface 41 of the reticle 4 coincides with the object-side focal plane of the eyepiece set 2. Since the first distance is equal to the second distance, when the switching assembly 3 rotates about the rotating shaft 13 to the second state, the display surface of the night vision assembly 5 will also coincide with the object-side focal plane of the eyepiece set 2. Meanwhile, the switching assembly 3 adopts a rotating mounting mode. It can adjust the positions of the night vision assembly 5 and the reticle 4 through its own movement, and save the space occupied by the switching assembly 3 during movement, thereby reducing the overall volume of the lens mechanism and lowering the cost of the sight.

In an optional embodiment, referring to FIGS. 21 and 23, the fourth compensation lens 9 is a positive optical power lens, and the positive optical power lens is configured to reduce the focal length of the main objective lens set 1. Specifically, optical power is a parameter describing the light focusing ability of a lens or an optical system in optics, and a positive optical power lens refers to a lens structure capable of converging light rays. The positive optical power lens may be a positive lens, an aspheric lens, a diffractive lens, etc., and the body of the positive optical power lens may be made of materials with high light transmittance and good optical performance such as glass, quartz or acrylic. The focal length of the main objective lens set 1 can be effectively shortened by disposing the fourth compensation lens 9, such that the sight can form a clear image with the assistance of the fourth compensation lens 9 in the night vision mode.

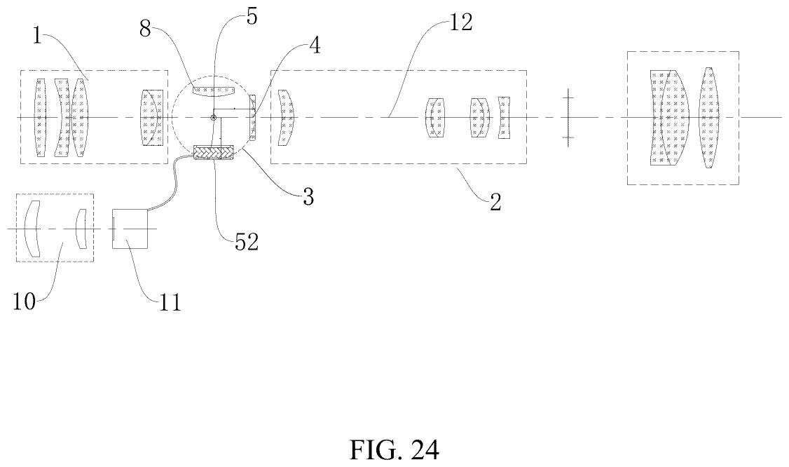

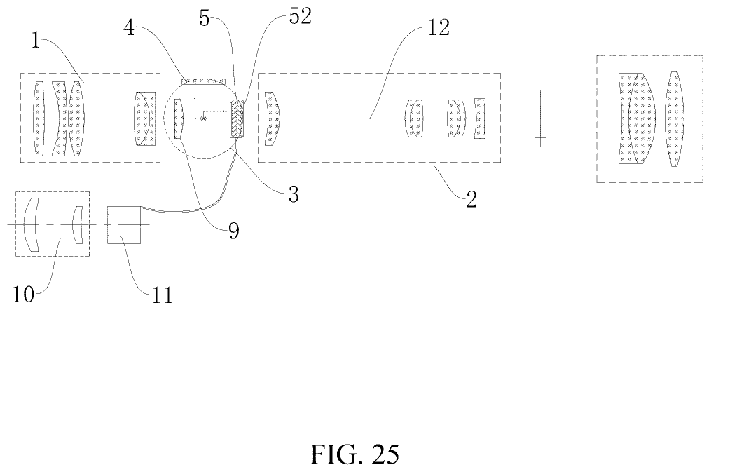

On the basis of the above technical feature of the fourth compensation lens 9, referring to FIGS. 24 and 25, the night vision assembly 5 includes image sensor 51 and display 52, and the lens mechanism further includes thermal imaging objective lens set 10 and thermal imaging core 11. The thermal imaging core 11 includes a detector and a signal processing unit. The detector is electrically connected to the signal processing unit, and the signal processing unit is electrically connected to the display 52. The image sensor 51 is configured to receive a light ray, convert the light ray into an electrical signal, and send the electrical signal to the display 52. The display 52 is configured to display an image. The image sensor 51 may be CMOS image sensor 51 or another type of detector. A light-receiving surface of the image sensor 51 serves as the light-receiving surface of the entire night vision assembly 5, and a light-emitting surface of the display 52 serves as the display surface of the entire night vision assembly 5. The image sensor 51 and the display 52 form the night vision assembly 5. The image sensor 51 captures the light ray and converts it into an electrical signal. The electrical signal is processed and enhanced and sent to the display 52. The processed signal is displayed through the display 52, such that a user can see an image that cannot be seen by the naked eye, thereby enhancing the visual ability of the user at night or in low-light environments.

In addition, the lens mechanism further includes thermal imaging objective lens set 10 and thermal imaging core 11. The thermal imaging core 11 includes a detector and a signal processing unit. The detector is electrically connected to the signal processing unit, and the signal processing unit is electrically connected to the display 52. Specifically, the thermal imaging objective lens set 10 may be a single lens, or may refer to a lens set composed of a plurality of lenses. The thermal imaging objective lens set 10 and the thermal imaging core 11 are sequentially disposed along a straight line parallel to the main optical axis 12. Since the detector of the thermal imaging core 11 can identify light waves with a wavelength of 8 μm to 14 μm and the lens material suitable for transmitting light waves of this wavelength is different from that for visible light waves, the thermal imaging core 11 and the night vision assembly 5 cannot share the objective lens set. Therefore, separate thermal imaging objective lens set 10 needs to be provided. By disposing the thermal imaging objective lens set 10 and the thermal imaging core 11 sequentially along a straight line parallel to the main optical axis 12, the user can aim in both the white light mode and the thermal imaging night vision mode, and the target image information acquired by the main objective lens set 1 and the thermal imaging objective lens set 10 is consistent. In this way, the entire lens mechanism is easy to operate.

The thermal imaging core 11 includes the detector and the signal processing unit. The detector is disposed on one end of the signal processing unit close to the thermal imaging objective lens set 10 and is electrically connected to the signal processing unit, and the signal processing unit is electrically connected to the display 52. Specifically, the detector is configured to acquire heat information and transmit the heat information to the signal processing unit. The signal processing unit converts the heat information into digital information and sends the digital information to the display 52. The display 52 converts the digital information into visual image information. When the switching assembly 3 is in the second state, the user can see the image on the display 52 through the eyepiece set 2, such that the user can aim in the thermal imaging night vision mode. In an embodiment, referring to FIG. 1, the lens mechanism satisfies the following relationship:

d₂=d₁/(1−1/n)

where, d₁ denotes the thickness of the reticle 4, d₂ denotes the thickness of the night vision assembly 5, and n denotes a refractive index of the reticle 4. Specifically, the thickness of the reticle 4 refers to the thickness of the reticle 4 along the direction of the main optical axis 12 when the switching assembly 3 is in the first state. The thickness of the night vision assembly 5 refers to the thickness of the night vision assembly 5 along the direction of the main optical axis 12 when the switching assembly 3 is in the second state. By making the thickness of the reticle 4 and the overall thickness of the night vision assembly 5 satisfy the above relationship, the sight allows the main objective lens set 1 and the eyepiece set 2 to share their structure and position in both the white light state and the night vision state. Clear images can be formed in both the white light state and the night vision state without changing the positions and structures of the main objective lens set 1 and the eyepiece set 2, thereby making the entire sight easy to operate.

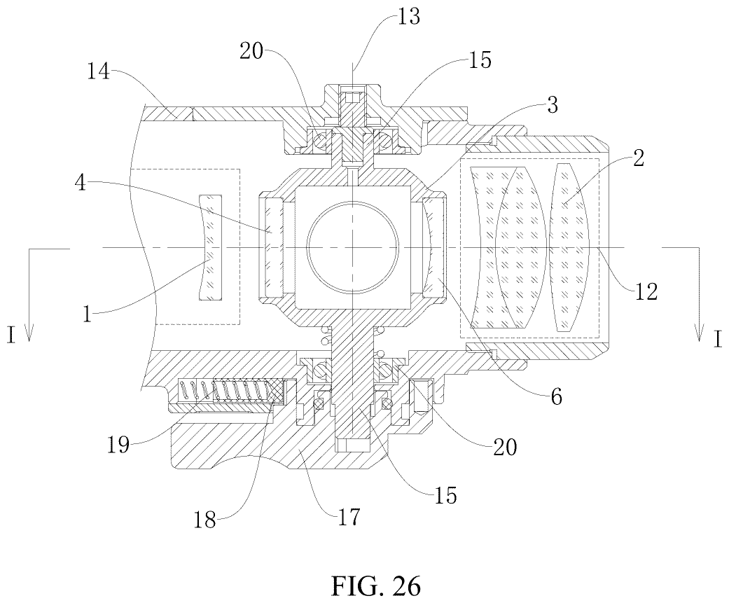

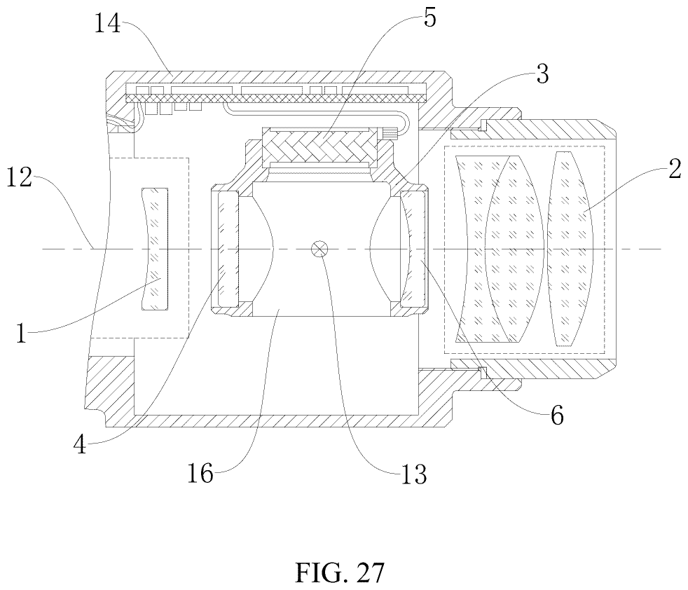

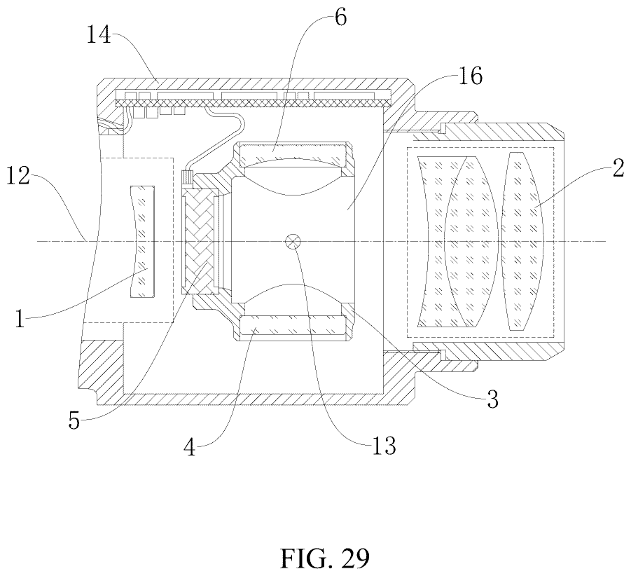

Referring to FIGS. 26 to 29, in a second aspect, a sight is provided, which includes lens barrel 14 and further includes the lens mechanism according to any one of the above embodiments. At least part of the switching assembly 3 is movably disposed inside the lens barrel 14. Specifically, the lens barrel 14 refers to a cylindrical component with a certain length, and the lens barrel 14 is provided with an accommodating space inside and openings at two ends. Compared with the sight in the prior art, by disposing the above lens mechanism inside the lens barrel 14, the reticle 4 and the night vision assembly 5 can be driven to switch between the first state and the second state only by the movement of the switching assembly 3, so as to realize rapid switching between the white light state and the night vision state. It is not necessary to replace or zero the sight during mode switching, and the cost of the sight can also be reduced.

In an embodiment, referring to FIGS. 26 to 29, two connecting rotating shafts 15 are respectively disposed on two ends of the switching assembly 3, and axes of the two connecting rotating shafts 15 coincide with the rotating shaft 13. The two connecting rotating shafts 15 are respectively rotatably connected to the lens barrel 14, thereby enabling the rotating mounting of the switching assembly 3. The reticle 4, the night vision assembly 5, and the compensation lens may be respectively disposed at different positions on the switching assembly 3, and the switching assembly 3 may be provided with avoidance structure 16. When the compensation lens is disposed opposite to the reticle 4, the avoidance structure 16 is disposed opposite to the night vision assembly 5, such that light rays can be transmitted through the night vision assembly 5 and the avoidance structure 16 when the switching assembly 3 is in the second state. When the compensation lens is disposed opposite to the night vision assembly 5, the avoidance structure 16 is disposed opposite to the reticle 4. Thus, light rays can be transmitted through the reticle 4 and the avoidance structure 16 when the switching assembly 3 is in the first state, thereby avoiding the switching assembly 3 blocking the light rays and thus affecting the imaging of the sight. In addition, the switching of the positions of the reticle 4, the night vision assembly 5, and the compensation lens is realized by the rotation of the switching assembly 3 about the rotating shaft 13, enabling easy mode switching of the sight. In addition, preferably, at least one of the two connecting rotating shafts 15 can extend through a side wall of the lens barrel 14 to an outside of the lens barrel 14, and a part of the connecting rotating shaft 15 located outside the lens barrel is provided with rotating handle 17. Thus, an operator can drive the switching assembly 3 to rotate easily, thereby facilitating the state switching of the switching assembly 3.

In addition, bearing 20 may be disposed between the connecting rotating shaft 15 and the lens barrel 14, which makes the rotation of the connecting rotating shaft 15 easy, thereby making the rotation of the switching assembly 3 easy and smooth.

In a specific embodiment, referring to FIGS. 26 to 29, the switching assembly 3 may be a rotary cylinder, the connecting rotating shafts 15 are disposed on the two ends of the rotary cylinder, and the rotary cylinder is rotatably disposed in the lens barrel 14 through the connecting rotating shafts 15. The axis of the rotary cylinder coincides with the rotating shaft 13, such that the rotary cylinder is rotatable about the rotating shaft 13. The reticle 4, the night vision assembly 5, and the compensation lens are disposed on a side wall of the rotary cylinder, and the side wall of the rotary cylinder is provided with an avoidance hole. When the compensation lens is disposed opposite to the reticle 4, the avoidance hole is disposed opposite to the night vision assembly 5. When the compensation lens is disposed opposite to the night vision assembly 5, the avoidance hole is disposed opposite to the reticle 4, which simplifies the overall structure of the switching assembly 3.

In an optional embodiment, referring to FIGS. 26 to 29, the lens barrel 14 may be provided with a positioning unit configured to position the switching assembly 3. The positioning unit includes positioning member 18 and positioning elastic member 19. The positioning member 18 is slidably disposed on the lens barrel 14, and the positioning elastic member 19 is disposed between the lens barrel 14 and the positioning member 18, and is configured to push the positioning member 18 in a direction close to the rotating handle 17 such that the positioning member 18 can abut against the rotating handle 17 to fix the rotating handle 17. Specifically, the positioning member 18 refers to a component with a certain volume, and the positioning member 18 may be in a block shape, a strip shape or a post shape. The positioning elastic member 19 refers to an elastic component with a certain length, and the positioning elastic member 19 may be a spring, a rubber post, etc. The lens barrel 14 may be provided with a sliding structure such as a sliding hole or a sliding groove. At least part of the positioning member 18 is slidably disposed in the sliding structure. The positioning elastic member 19 is also disposed in the sliding structure and is configured to apply a force towards the rotating handle 17 to the positioning member 18, such that the positioning member 18 abuts against the rotating handle 17. The rotating handle 17 is kept fixed when no external force is applied to the rotating handle 17, such that the connecting rotating shafts 15 and the switching assembly 3 are kept fixed.

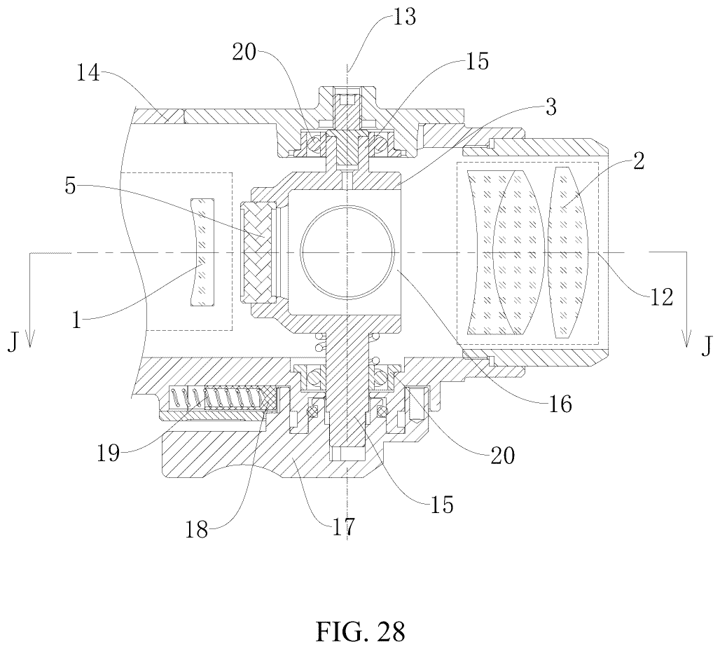

On the basis of the above feature of the positioning unit, referring to FIGS. 26 and 28, the rotating handle 17 is provided with positioning grooves configured to cooperate with an end of the positioning member 18. There may be two positioning grooves, and the positions of the two positioning grooves may correspond to the positions of the switching assembly 3 in the first state and the second state, respectively. For example, when the switching assembly 3 is in the first state, the end of the positioning member 18 can engage with the positioning groove. When the switching assembly 3 is in the second state, the end of the positioning member 18 can engage with the other positioning groove. When the switching assembly 3 needs to rotate, the switching assembly 3 can disengage the end of the positioning member 18 from the positioning groove under the action of an external force. By disposing the positioning grooves to cooperate with the end of the positioning member 18, the switching assembly 3 can be stable when in the first state or the second state.

The above described are merely preferred embodiments of the present disclosure, which only specifically sets forth the technical principles of the present disclosure. They are merely intended to explain the principles of the present disclosure, and shall not be construed as a limitation on the scope of protection of the present disclosure in any manner. Based on the explanations herein, all modifications, equivalent substitutions, and improvements made within the spirit and principles of the present disclosure, as well as other specific implementations of the present disclosure that can be conceived of by those skilled in the art without the exertion of creative work, shall all be included within the scope of protection of the present disclosure.

What is claimed is:

1. A lens mechanism, comprising: a main objective lens set, an eyepiece set, and a switching assembly, wherein the main objective lens set and the eyepiece set are disposed at an interval along a main optical axis; the switching assembly is movably disposed between the main objective lens set and the eyepiece set; the switching assembly is provided with a reticle and a night vision assembly; the switching assembly has a first state and a second state; when the switching assembly is in the first state, the reticle is located on the main optical axis and the night vision assembly deviates from the main optical axis; and when the switching assembly is in the second state, the night vision assembly is located on the main optical axis and the reticle deviates from the main optical axis.

2. The lens mechanism according to claim 1, wherein when the switching assembly is in the first state, a pattern surface of the reticle coincides with an image-side focal plane of the main objective lens set; when the switching assembly is in the second state, a light-receiving surface of the night vision assembly coincides with the image-side focal plane of the main objective lens set, and a display surface of the night vision assembly coincides with an object-side focal plane of the eyepiece set; the lens mechanism further comprises a first compensation lens; the first compensation lens is movable between a first position corresponding to the first state and a second position corresponding to the second state; at the first position, the first compensation lens is located on the main optical axis and between the reticle and the eyepiece set, and the first compensation lens is configured to make the object-side focal plane of the eyepiece set coincide with the image-side focal plane of the main objective lens set; and at the second position, the first compensation lens deviates from the main optical axis.

3. The lens mechanism according to claim 2, wherein the first compensation lens is disposed on the switching assembly and is movable with the switching assembly; the first compensation lens is disposed opposite to the reticle; and an optical axis of the first compensation lens coincides with an optical axis of the reticle.

4. The lens mechanism according to claim 1, wherein when the switching assembly is in the first state, an image-side focal plane of the main objective lens set coincides with a pattern surface of the reticle, and an object-side focal plane of the eyepiece set further coincides with the pattern surface of the reticle; when the switching assembly is in the second state, a light-receiving surface of the night vision assembly coincides with the image-side focal plane of the main objective lens set; the lens mechanism comprises a second compensation lens; the second compensation lens is movable between a third position corresponding to the first state and a fourth position corresponding to the second state; at the fourth position, the second compensation lens is located on the main optical axis and between the night vision assembly and the eyepiece set, wherein when the switching assembly is in the second state, a display surface of the night vision assembly coincides with the object-side focal plane of the eyepiece set; and at the third position, the second compensation lens deviates from the main optical axis.

5. The lens mechanism according to claim 4, wherein the second compensation lens is disposed on the switching assembly and is movable with the switching assembly; the second compensation lens is disposed opposite to the night vision assembly; and an optical axis of the second compensation lens coincides with an optical axis of the night vision assembly.

6. The lens mechanism according to claim 1, wherein when the switching assembly is in the first state, a pattern surface of the reticle coincides with an object-side focal plane of the eyepiece set; when the switching assembly is in the second state, a light-receiving surface of the night vision assembly coincides with an image-side focal plane of the main objective lens set, and a display surface of the night vision assembly coincides with the object-side focal plane of the eyepiece set; the lens mechanism further comprises a third compensation lens; the third compensation lens is movable between a fifth position corresponding to the first state and a sixth position corresponding to the second state; at the fifth position, the third compensation lens is located on the main optical axis and between the reticle and the main objective lens set, and the third compensation lens is configured to make the object-side focal plane of the eyepiece set coincide with the image-side focal plane of the main objective lens set; and at the sixth position, the third compensation lens deviates from the main optical axis.

7. The lens mechanism according to claim 6, wherein the third compensation lens is disposed on the switching assembly and is movable with the switching assembly; the third compensation lens is disposed opposite to the reticle; and an optical axis of the third compensation lens coincides with an optical axis of the reticle.

8. The lens mechanism according to claim 1, wherein when the switching assembly is in the first state, an image-side focal plane of the main objective lens set coincides with a pattern surface of the reticle, and an object-side focal plane of the eyepiece set further coincides with the pattern surface of the reticle; when the switching assembly is in the second state, a display surface of the night vision assembly coincides with the object-side focal plane of the eyepiece set; the lens mechanism comprises a fourth compensation lens; an optical axis of the fourth compensation lens coincides with an optical axis of the night vision assembly; the fourth compensation lens is movable between a seventh position corresponding to the first state and an eighth position corresponding to the second state; at the eighth position, the fourth compensation lens is located on the main optical axis and between the night vision assembly and the main objective lens set, wherein when the switching assembly is in the second state, the display surface of the night vision assembly coincides with the image-side focal plane of the main objective lens set; and at the seventh position, the fourth compensation lens deviates from the main optical axis.

9. The lens mechanism according to claim 8, wherein the fourth compensation lens is disposed on the switching assembly and is movable with the night switching assembly; the fourth compensation lens is disposed opposite to the night vision assembly; and the optical axis of the fourth compensation lens coincides with an optical axis of the switching assembly.

10. The lens mechanism according to claim 2, wherein the night vision assembly comprises an image sensor and a display; the lens mechanism further comprises a thermal imaging objective lens set and a thermal imaging core; the thermal imaging core comprises a detector and a signal processing unit; the detector is electrically connected to the signal processing unit; and the signal processing unit is electrically connected to the display.

11. The lens mechanism according to claim 2, wherein the switching assembly has a degree of freedom to rotate about a rotating shaft; and the rotating shaft is perpendicular to and intersects with the main optical axis.

12. The lens mechanism according to claim 1, wherein the lens mechanism satisfies a following relationship:
d₂=d₁/(1−1/n)
wherein d₁ denotes a thickness of the reticle, d₂ denotes a thickness of the night vision assembly, and n denotes a refractive index of the reticle.

13. A sight, comprising: a lens barrel, wherein the sight further comprises the lens mechanism according to claim 1, and at least part of the switching assembly is movably disposed inside the lens barrel.

14. The lens mechanism according to claim 3, wherein the night vision assembly comprises an image sensor and a display; the lens mechanism further comprises a thermal imaging objective lens set and a thermal imaging core; the thermal imaging core comprises a detector and a signal processing unit; the detector is electrically connected to the signal processing unit; and the signal processing unit is electrically connected to the display.

15. The lens mechanism according to claim 4, wherein the night vision assembly comprises an image sensor and a display; the lens mechanism further comprises a thermal imaging objective lens set and a thermal imaging core; the thermal imaging core comprises a detector and a signal processing unit; the detector is electrically connected to the signal processing unit; and the signal processing unit is electrically connected to the display.

16. The lens mechanism according to claim 5, wherein the night vision assembly comprises an image sensor and a display; the lens mechanism further comprises a thermal imaging objective lens set and a thermal imaging core; the thermal imaging core comprises a detector and a signal processing unit; the detector is electrically connected to the signal processing unit; and the signal processing unit is electrically connected to the display.

17. The lens mechanism according to claim 6, wherein the night vision assembly comprises an image sensor and a display; the lens mechanism further comprises a thermal imaging objective lens set and a thermal imaging core; the thermal imaging core comprises a detector and a signal processing unit; the detector is electrically connected to the signal processing unit; and the signal processing unit is electrically connected to the display.

18. The lens mechanism according to claim 7, wherein the night vision assembly comprises an image sensor and a display; the lens mechanism further comprises a thermal imaging objective lens set and a thermal imaging core; the thermal imaging core comprises a detector and a signal processing unit; the detector is electrically connected to the signal processing unit; and the signal processing unit is electrically connected to the display.

19. The lens mechanism according to claim 8, wherein the night vision assembly comprises an image sensor and a display; the lens mechanism further comprises a thermal imaging objective lens set and a thermal imaging core; the thermal imaging core comprises a detector and a signal processing unit; the detector is electrically connected to the signal processing unit; and the signal processing unit is electrically connected to the display.

20. The lens mechanism according to claim 9, wherein the night vision assembly comprises an image sensor and a display; the lens mechanism further comprises a thermal imaging objective lens set and a thermal imaging core; the thermal imaging core comprises a detector and a signal processing unit; the detector is electrically connected to the signal processing unit; and the signal processing unit is electrically connected to the display.
